(19) United States
(12) Patent Application Publication
(10) Pub. No.: US 2026/0189645 A1
(43) Pub. Date: Jul. 2, 2026

(54) ELECTRONIC DEVICE INCLUDING STORAGE MEDIUM

(71) Applicant: Samsung Electronics Co., Ltd., Suwon-si (KR)

(72) Inventors: Byungmin LEE, Suwon-si (KR); Haesoo KIM, Suwon-si (KR); Seungmin BAE, Suwon-si (KR); Hyunje CHO, Suwon-si (KR); Junhwa CHOI, Suwon-si (KR)

(21) Appl. No.: 19/544,667

(22) Filed: Feb. 19, 2026

Related U.S. Application Data
(63) Continuation of application No. PCT/KR2024/012442, filed on Aug. 21, 2024.

(30) Foreign Application Priority Data
Aug. 21, 2023 (KR) 10-2023-0109074
Oct. 12, 2023 (KR) 10-2023-0136234

(51) Int. Cl. H04M 1/02

(52) U.S. Cl. CPC H04M 1/0274

(57) ABSTRACT

An electronic device is provided. The electronic device includes a housing including a first through hole and a second through-hole, a socket disposed inside the housing and configured to seat a storage medium inserted in a first direction through the first through hole sits in the socket, and a locking structure disposed in the socket, wherein the locking structure includes an operation cam configured to be movable with the storage medium, a locking bar configured to allow or restrict movement of the operation cam, and a release lever, and wherein the locking structure is configured to hold the storage medium disposed in the socket or move the storage medium disposed in the socket in a second direction opposite to the first direction by using at least one of the operation cam or the release lever to discharge the storage medium through the first through hole to the outside of the electronic device.

### CROSS-REFERENCE TO RELATED APPLICATION(S)

This application is a continuation application, claiming priority under 35 U.S.C. § 365(c), of an International application No. PCT/KR 2024/012442, filed on Aug. 21, 2024, which is based on and claims the benefit of a Korean patent application number 10-2023-0109074, filed on Aug. 21, 2023, in the Korean Intellectual Property Office, and of a Korean patent application number 10-2023-0136234, filed on Oct. 12, 2023, in the Korean Intellectual Property Office, the disclosure of each of which is incorporated by reference herein in its entirety.

### BACKGROUND

### 1. Field

The disclosure relates to an electronic device including a storage medium.

### 2. Description of Related Art

With the development of information and communication technology and semiconductor technology, various functions are packed in one portable electronic device. For example, an electronic device may implement not only communication functions but also entertainment functions, such as playing games, multimedia functions, such as playing music and videos, communication and security functions for mobile banking, and scheduling or e-wallet functions. These electronic devices have been downsized to be conveniently carried by users.

A portable electronic device (e.g., smartphone, laptop, tablet personal computer (PC)) may include a storage medium such as a subscriber identification module card (or user authentication module card) or memory card. Such a storage medium may be built into an electronic device or configured to be easily replaced and/or added by a user. For example, an electronic device may include a socket for receiving a storage medium. Such a socket may include terminal pins for connecting with a storage medium and/or a locking structure for detachably securing the storage medium to the socket.

The above information is presented as background information only to assist with an understanding of the disclosure. No determination has been made, and no assertion is made, as to whether any of the above might be applicable as prior art with regard to the disclosure.

### SUMMARY

Aspects of the disclosure are to address at least the above-mentioned problems and/or disadvantages and to provide at least the advantages described below. Accordingly, an aspect of the disclosure is to provide an electronic device including a storage medium.

Additional aspects will be set forth in part in the description which follows and, in part, will be apparent from the description, or may be learned by practice of the presented embodiments.

In accordance with an aspect of the disclosure, an electronic device is provided. The electronic device includes a housing including a first through hole and a second through hole formed around the first through hole, a socket disposed inside the housing and configured to seat a storage medium inserted in a first direction through the first through hole, and a locking structure disposed in the socket, wherein the locking structure includes an operation cam configured to be movable with the storage medium, a locking bar configured to allow or restrict movement of the operation cam, and a release lever, and wherein the locking structure is configured to hold the storage medium disposed in the socket or move the storage medium disposed in the socket in a second direction opposite to the first direction by using at least one of the operation cam or the release lever to discharge the storage medium through the first through hole to the outside of the electronic device.

In accordance with another aspect of the disclosure, an electronic device is provided. The electronic device includes a housing including a first through hole and a second through hole, a socket disposed inside the housing and configured to seat a storage medium inserted in a first direction through the first through hole, and a locking structure disposed in the socket, wherein the locking structure includes an operation cam configured to be movable with the storage medium, a locking bar configured to allow or restrict movement of the operation cam, and an elastic member disposed to press the operation cam in a second direction opposite to the first direction, and wherein, when the operation cam is moved in the first direction or the second direction based on a pressing force of a push-tool inserted into the socket through the second through hole, the storage medium disposed in the socket is moved in the second direction and discharged to the outside of the electronic device.

Other aspects, advantages, and salient features of the disclosure will become apparent to those skilled in the art from the following detailed description, which, taken in conjunction with the annexed drawings, discloses various embodiments of the disclosure.

### BRIEF DESCRIPTION OF THE DRAWINGS

The above and other aspects, features, and advantages of certain embodiments of the disclosure will be more apparent from the following description taken in conjunction with the accompanying drawings, in which:

FIG. 1 is a block diagram illustrating an electronic device in a network environment according to an embodiment of the disclosure;

FIG. 2 is a front perspective view illustrating an electronic device according to an embodiment of the disclosure;

FIG. 3 is a rear perspective view illustrating an electronic device according to an embodiment of the disclosure;

FIG. 4 is a front exploded perspective view illustrating an electronic device according to an embodiment of the disclosure;

FIG. 5 is a rear exploded perspective view illustrating an electronic device according to an embodiment of the disclosure;

FIG. 6A is a plan view illustrating a state in which a storage medium is mounted in a socket, according to an embodiment of the disclosure;

FIG. 6B is an enlarged view illustrating portion A of FIG. 6A, according to an embodiment of the disclosure;

FIG. 6C is an enlarged view illustrating portion B of FIG. 6A, according to an embodiment of the disclosure;

FIG. 7A is a plan view illustrating a state in which a storage medium is discharged from a socket, according to an embodiment of the disclosure;

FIG. 7B is an enlarged view illustrating portion C of FIG. 7A, according to an embodiment of the disclosure;

FIG. 7C is an enlarged view illustrating portion D of FIG. 7A, according to an embodiment of the disclosure;

FIG. 8 is a plan view illustrating operation of a locking bar of a locking structure, according to an embodiment of the disclosure;

FIGS. 9A, 9B, 9C, 9D, and 9E are plan views illustrating an operation of mounting a storage medium in a socket and an operation of discharging a socket using a locking lever, according to various embodiments of the disclosure;

FIG. 10 is a plan view illustrating a state in which a storage medium is mounted in a socket, according to an embodiment of the disclosure;

FIG. 11 is a plan view illustrating a state in which a storage medium is discharged from a socket, according to an embodiment of the disclosure;

FIG. 12 is a perspective view illustrating insertion of a push-tool into an electronic device, according to an embodiment of the disclosure;

FIG. 13A is a perspective view illustrating a state in which a storage medium is mounted in a socket, according to an embodiment of the disclosure;

FIG. 13B is a perspective view illustrating a state in which a storage medium is discharged from a socket, according to an embodiment of the disclosure; and

FIGS. 14A, 14B, 14C, 14D, and 14E are plan views illustrating an operation of mounting a storage medium in a socket and an operation of discharging a socket using a push-tool, according to various embodiments of the disclosure.

Throughout the drawings, like reference numerals will be understood to refer to like parts, components, and structures.

### DETAILED DESCRIPTION

The following description with reference to the accompanying drawings is provided to assist in a comprehensive understanding of various embodiments of the disclosure as defined by the claims and their equivalents. It includes various specific details to assist in that understanding but these are to be regarded as merely exemplary. Accordingly, those of ordinary skill in the art will recognize that various changes or modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and equivalents.

It is to be understood that the singular forms “a,” “an,” and “the” include plural references unless the context clearly dictates otherwise. Thus, for example, reference to “a component surface” includes reference to one or more of such surfaces.

It should be appreciated that the blocks in each flowchart and combinations of the flowcharts may be performed by one or more computer programs which include instructions. The entirety of the one or more computer programs may be stored in a single memory device or the one or more computer programs may be divided with different portions stored in different multiple memory devices.

Any of the functions or operations described herein can be processed by one processor or a combination of processors. The one processor or the combination of processors is circuitry performing processing and includes circuitry like an application processor (AP, e.g. a central processing unit (CPU)), a communication processor (CP, e.g., a modem), a graphics processing unit (GPU), a neural processing unit (NPU) (e.g., an artificial intelligence (AI) chip), a wireless fidelity (Wi-Fi) chip, a Bluetooth® chip, a global positioning system (GPS) chip, a near field communication (NFC) chip, connectivity chips, a sensor controller, a touch controller, a finger-print sensor controller, a display driver integrated circuit (IC), an audio CODEC chip, a universal serial bus (USB) controller, a camera controller, an image processing IC, a microprocessor unit (MPU), a system on chip (SoC), an IC, or the like.

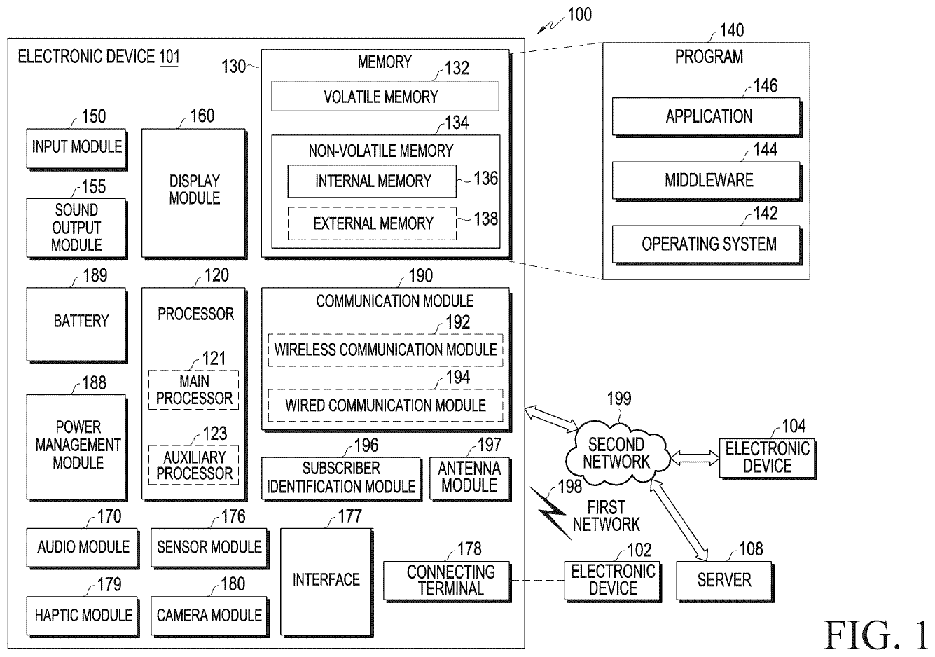

FIG. 1 is a block diagram illustrating an electronic device in a network environment according to an embodiment of the disclosure.

Referring to FIG. 1, the electronic device 101 in the network environment 100 may communicate with an electronic device 102 via a first network 198 (e.g., a short-range wireless communication network), or an electronic device 104 or a server 108 via a second network 199 (e.g., a long-range wireless communication network). According to an embodiment, the electronic device 101 may communicate with the electronic device 104 via the server 108. According to an embodiment, the electronic device 101 may include a processor 120, memory 130, an input module 150, a sound output module 155, a display module 160, an audio module 170, a sensor module 176, an interface 177, a connecting terminal 178, a haptic module 179, a camera module 180, a power management module 188, a battery 189, a communication module 190, a subscriber identification module (SIM) 196, or an antenna module 197. In an embodiment, at least one (e.g., the connecting terminal 178) of the components may be omitted from the electronic device 101, or one or more other components may be added in the electronic device 101. In an embodiment, some (e.g., the sensor module 176, the camera module 180, or the antenna module 197) of the components may be integrated into a single component (e.g., the display module 160).

The processor 120 may execute, for example, software (e.g., the program 140) to control at least one other component (e.g., a hardware or software component) of the electronic device 101 coupled with the processor 120, and may perform various data processing or computation. According to one embodiment, as at least part of the data processing or computation, the processor 120 may store a command or data received from another component (e.g., the sensor module 176 or the communication module 190) in volatile memory 132, process the command or the data stored in the volatile memory 132, and store resulting data in non-volatile memory 134. According to an embodiment, the processor 120 may include a main processor 121 (e.g., a central processing unit (CPU) or an application processor (AP)), or an auxiliary processor 123 (e.g., a graphics processing unit (GPU), a neural processing unit (NPU), an image signal processor (ISP), a sensor hub processor, or a communication processor (CP)) that is operable independently from, or in conjunction with, the main processor 121. For example, when the electronic device 101 includes the main processor 121 and the auxiliary processor 123, the auxiliary processor 123 may be configured to use lower power than the main processor 121 or to be specified for a designated function. The auxiliary processor 123 may be implemented as separate from, or as part of the main processor 121.

The auxiliary processor 123 may control at least some of functions or states related to at least one component (e.g., the display module 160, the sensor module 176, or the communication module 190) among the components of the electronic device 101, instead of the main processor 121 while the main processor 121 is in an inactive (e.g., sleep) state, or together with the main processor 121 while the main processor 121 is in an active state (e.g., executing an application). According to an embodiment, the auxiliary processor 123 (e.g., an image signal processor or a communication processor) may be implemented as part of another component (e.g., the camera module 180 or the communication module 190) functionally related to the auxiliary processor 123. According to an embodiment, the auxiliary processor 123 (e.g., the neural processing unit) may include a hardware structure specified for artificial intelligence model processing. The artificial intelligence model may be generated via machine learning. Such learning may be performed, e.g., by the electronic device 101 where the artificial intelligence is performed or via a separate server (e.g., the server 108). Learning algorithms may include, but are not limited to, e.g., supervised learning, unsupervised learning, semi-supervised learning, or reinforcement learning. The artificial intelligence model may include a plurality of artificial neural network layers. The artificial neural network may be a deep neural network (DNN), a convolutional neural network (CNN), a recurrent neural network (RNN), a restricted Boltzmann machine (RBM), a deep belief network (DBN), a bidirectional recurrent deep neural network (BRDNN), deep Q-network or a combination of two or more thereof but is not limited thereto. The artificial intelligence model may, additionally or alternatively, include a software structure other than the hardware structure.

The memory 130 may store various data used by at least one component (e.g., the processor 120 or the sensor module 176) of the electronic device 101. The various data may include, for example, software (e.g., the program 140) and input data or output data for a command related thereto. The memory 130 may include the volatile memory 132 or the non-volatile memory 134.

The program 140 may be stored in the memory 130 as software, and may include, for example, an operating system (OS) 142, middleware 144, or an application 146.

The input module 150 may receive a command or data to be used by other component (e.g., the processor 120) of the electronic device 101, from the outside (e.g., a user) of the electronic device 101. The input module 150 may include, for example, a microphone, a mouse, a keyboard, keys (e.g., buttons), or a digital pen (e.g., a stylus pen).

The sound output module 155 may output sound signals to the outside of the electronic device 101. The sound output module 155 may include, for example, a speaker or a receiver. The speaker may be used for general purposes, such as playing multimedia or playing record. The receiver may be used for receiving incoming calls. According to an embodiment, the receiver may be implemented as separate from, or as part of the speaker.

The display module 160 may visually provide information to the outside (e.g., a user) of the electronic device 101. The display module 160 may include, for example, a display, a hologram device, or a projector and control circuitry to control a corresponding one of the display, hologram device, and projector. According to an embodiment, the display module 160 may include a touch sensor configured to detect a touch, or a pressure sensor configured to measure the intensity of a force generated by the touch.

The audio module 170 may convert a sound into an electrical signal and vice versa. According to an embodiment, the audio module 170 may obtain the sound via the input module 150, or output the sound via the sound output module 155 or a headphone of an external electronic device (e.g., an electronic device 102) directly (e.g., wiredly) or wirelessly coupled with the electronic device 101.

The sensor module 176 may detect an operation state (e.g., power or temperature) of the electronic device 101 or an external environmental state (e.g., the user's state), and then generate an electrical signal or data value corresponding to the detected state. According to an embodiment, the sensor module 176 may include, for example, a gesture sensor, a gyro sensor, an atmospheric pressure sensor, a magnetic sensor, an acceleration sensor, a grip sensor, a proximity sensor, a color sensor, an infrared (IR) sensor, a biometric sensor, a temperature sensor, a humidity sensor, or an illuminance sensor.

The interface 177 may support one or more specified protocols to be used for the electronic device 101 to be coupled with the external electronic device (e.g., the electronic device 102) directly (e.g., wiredly) or wirelessly. According to an embodiment, the interface 177 may include, for example, a high definition multimedia interface (HDMI), a universal serial bus (USB) interface, a secure digital (SD) card interface, or an audio interface.

A connecting terminal 178 may include a connector via which the electronic device 101 may be physically connected with the external electronic device (e.g., the electronic device 102). According to an embodiment, the connecting terminal 178 may include, for example, a HDMI connector, a USB connector, a SD card connector, or an audio connector (e.g., a headphone connector).

The haptic module 179 may convert an electrical signal into a mechanical stimulus (e.g., a vibration or motion) or electrical stimulus which may be recognized by a user via his tactile sensation or kinesthetic sensation. According to an embodiment, the haptic module 179 may include, for example, a motor, a piezoelectric element, or an electric stimulator.

The camera module 180 may capture a still image or moving images. According to an embodiment, the camera module 180 may include one or more lenses, image sensors, image signal processors, or flashes.

The power management module 188 may manage power supplied to the electronic device 101. According to an embodiment, the power management module 188 may be implemented as at least part of, for example, a power management integrated circuit (PMIC).

The battery 189 may supply power to at least one component of the electronic device 101. According to an embodiment, the battery 189 may include, for example, a primary cell which is not rechargeable, a secondary cell which is rechargeable, or a fuel cell.

The communication module 190 may support establishing a direct (e.g., wiredly) communication channel or a wireless communication channel between the electronic device 101 and the external electronic device (e.g., the electronic device 102, the electronic device 104, or the server 108) and performing communication via the established communication channel. The communication module 190 may include one or more communication processors that are operable independently from the processor 120 (e.g., the application processor (AP)) and supports a direct (e.g., wired) communication or a wireless communication. According to an embodiment, the communication module 190 may include a wireless communication module 192 (e.g., a cellular communication module, a short-range wireless communication module, or a global navigation satellite system (GNSS) communication module) or a wired communication module 194 (e.g., a local area network (LAN) communication module or a power line communication (PLC) module). A corresponding one of these communication modules may communicate with the external electronic device 104 via a first network 198 (e.g., a short-range communication network, such as Bluetooth™, wireless-fidelity (Wi-Fi) direct, or infrared data association (IrDA)) or a second network 199 (e.g., a long-range communication network, such as a legacy cellular network, a fifth generation (5G) network, a next-generation communication network, the Internet, or a computer network (e.g., local area network (LAN) or wide area network (WAN)). These various types of communication modules may be implemented as a single component (e.g., a single chip), or may be implemented as multi components (e.g., multi chips) separate from each other. The wireless communication module 192 may identify or authenticate the electronic device 101 in a communication network, such as the first network 198 or the second network 199, using subscriber information (e.g., international mobile subscriber identity (IMSI)) stored in the subscriber identification module 196.

The wireless communication module 192 may support a 5G network, after a fourth generation (4G) network, and next-generation communication technology, e.g., new radio (NR) access technology. The NR access technology may support enhanced mobile broadband (eMBB), massive machine type communications (mMTC), or ultra-reliable and low-latency communications (URLLC). The wireless communication module 192 may support a high-frequency band (e.g., the millimeter wave (mmWave) band) to achieve, e.g., a high data transmission rate. The wireless communication module 192 may support various technologies for securing performance on a high-frequency band, such as, e.g., beamforming, massive multiple-input and multiple-output (massive MIMO), full dimensional MIMO (FD-MIMO), array antenna, analog beam-forming, or large scale antenna. The wireless communication module 192 may support various requirements specified in the electronic device 101, an external electronic device (e.g., the electronic device 104), or a network system (e.g., the second network 199). According to an embodiment, the wireless communication module 192 may support a peak data rate (e.g., 20Gbps or more) for implementing eMBB, loss coverage (e.g., 164 dB or less) for implementing mMTC, or user plane (U-plane) latency (e.g., 0.5 ms or less for each of downlink (DL) and uplink (UL), or a round trip of 1 ms or less) for implementing URLLC.

The antenna module 197 may transmit or receive a signal or power to or from the outside (e.g., the external electronic device). According to an embodiment, the antenna module 197 may include one antenna including a radiator formed of a conductor or conductive pattern formed on a substrate (e.g., a printed circuit board (PCB)). According to an embodiment, the antenna module 197 may include a plurality of antennas (e.g., an antenna array). In this case, at least one antenna appropriate for a communication scheme used in a communication network, such as the first network 198 or the second network 199, may be selected from the plurality of antennas by, e.g., the communication module 190. The signal or the power may then be transmitted or received between the communication module 190 and the external electronic device via the selected at least one antenna. According to an embodiment, other parts (e.g., radio frequency integrated circuit (RFIC)) than the radiator may be further formed as part of the antenna module 197.

According to an embodiment, the antenna module 197 may form a mmWave antenna module. According to an embodiment, the mmWave antenna module may include a printed circuit board, a RFIC disposed on a first surface (e.g., the bottom surface) of the printed circuit board, or adjacent to the first surface and capable of supporting a designated high-frequency band (e.g., the mmWave band), and a plurality of antennas (e.g., array antennas) disposed on a second surface (e.g., the top or a side surface) of the printed circuit board, or adjacent to the second surface and capable of transmitting or receiving signals of the designated high-frequency band.

At least some of the above-described components may be coupled mutually and communicate signals (e.g., commands or data) therebetween via an inter-peripheral communication scheme (e.g., a bus, general purpose input and output (GPIO), serial peripheral interface (SPI), or mobile industry processor interface (MIPI)).

According to an embodiment, instructions or data may be transmitted or received between the electronic device 101 and the external electronic device 104 via the server 108 coupled with the second network 199. The external electronic devices 102 or 104 each may be a device of the same or a different type from the electronic device 101. According to an embodiment, all or some of operations to be executed at the electronic device 101 may be executed at one or more of the external electronic devices 102, 104, or 108. For example, if the electronic device 101 should perform a function or a service automatically, or in response to a request from a user or another device, the electronic device 101, instead of, or in addition to, executing the function or the service, may request the one or more external electronic devices to perform at least part of the function or the service. The one or more external electronic devices receiving the request may perform the at least part of the function or the service requested, or an additional function or an additional service related to the request, and transfer an outcome of the performing to the electronic device 101. The electronic device 101 may provide the outcome, with or without further processing of the outcome, as at least part of a reply to the request. To that end, a cloud computing, distributed computing, mobile edge computing (MEC), or client-server computing technology may be used, for example. The electronic device 101 may provide ultra low-latency services using, e.g., distributed computing or mobile edge computing. In an embodiment, the external electronic device 104 may include an internet-of-things (IoT) device. The server 108 may be an intelligent server using machine learning and/or a neural network. According to an embodiment, the external electronic device 104 or the server 108 may be included in the second network 199. The electronic device 101 may be applied to intelligent services (e.g., smart home, smart city, smart car, or healthcare) based on 5G communication technology or IoT-related technology.

In the following detailed description, a length direction, a width direction, and/or a thickness direction of the electronic device may be mentioned and may be defined as a ‘Y-axis direction,’ ‘X-axis direction’, and/or ‘Z-axis direction,’ respectively. In an embodiment, regarding the direction that a component faces, ‘negative/positive (−/+)’ may be mentioned together with the orthogonal coordinate system illustrated in the drawings. For example, the front surface of the electronic device or housing may be defined as a ‘surface facing in the +Z direction,’ and the rear surface may be defined as a ‘surface facing in the −Z direction’. In an embodiment, the side surface of the electronic device or housing may include an area facing in the +X direction, an area facing in the +Y direction, an area facing in the −X direction, and/or an area facing in the−Y direction. In another embodiment, the ‘X-axis direction’ may mean including both the ‘−X direction’ and the ‘+X direction’. It should be noted that the directions are so defined with respect to the Cartesian coordinate system shown in the drawings for the sake of brevity of description, and the description of these directions or components do not limit an embodiment of the disclosure. For example, the direction in which the front surface or rear surface faces may be varied depending on the unfolded state or folded state of the electronic device, and the above-mentioned directions may be interpreted as different ones depending on the user's way to grip.

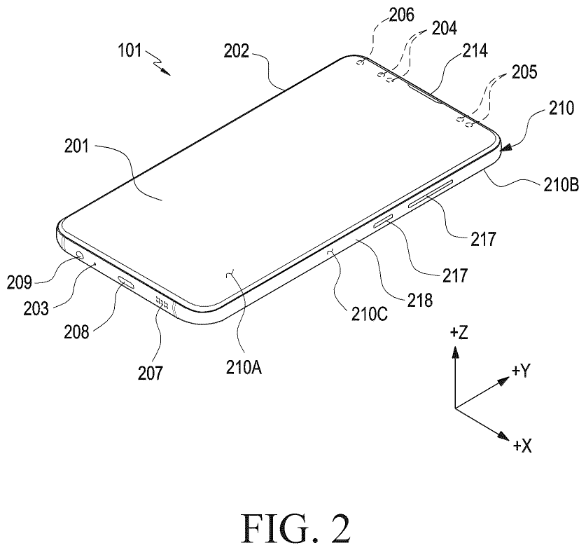

FIG. 2 is a front perspective view illustrating an electronic device according to an embodiment of the disclosure.

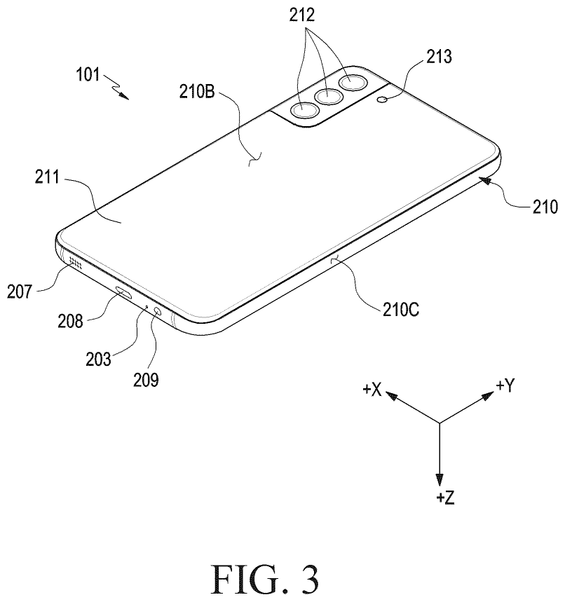

FIG. 3 is a perspective view illustrating a rear surface of the electronic device of FIG. 2 according to an embodiment of the disclosure.

The configuration of the electronic device 101 of FIGS. 2 and 3 may be identical in whole or part to the configuration of the electronic device 101 of FIG. 1.

Referring to FIGS. 2 and 3, according to an embodiment, an electronic device 101 may include a housing 210 including a first surface (or front surface) 210A, a second surface (or rear surface) 210B, and a side surface 210C surrounding the space between the first surface 210A and the second surfaces 210B. According to an embodiment (not illustrated), the housing 210 may denote a structure forming the first surface 210A of FIG. 2, the second surface 210B of FIG. 3, and some of the side surfaces 210C. According to an embodiment, at least part of the first surface 210A may have a substantially transparent front plate 202 (e.g., a glass plate or polymer plate including various coat layers). The second surface 210B may be formed by a rear plate 211 that is substantially opaque. The rear plate 211 may be formed of, e.g., laminated or colored glass, ceramic, polymer, metal (e.g., aluminum, stainless steel (STS), or magnesium), or a combination of at least two thereof. The side surface 210C may be formed by a side structure 218 that couples to the front plate 202 and the rear plate 211 and includes a metal and/or polymer. In an embodiment, the rear plate 211 and the side structure 218 may be integrally formed together and include the same material (e.g., a metal, such as aluminum).

Although not shown, the front plate 202 may include area(s) that bend from at least a portion of an edge toward the rear plate 211 and seamlessly extend. In an embodiment, only one of the areas of the front plate 202 (or the rear plate 211), which bend to the rear plate 211 (or front plate 202) and extend may be included in one edge of the first surface 210A. According to an embodiment, the front plate 202 or rear plate 211 may be substantially flat and, in this case, may not include an area bending and extending. When an area bending and extending is included, the thickness of the electronic device 101 at the portion including the area bending and extending may be smaller than the thickness of the rest.

According to an embodiment, the electronic device 101 may include at least one of a display 201, an audio module (not illustrated) (e.g., the audio module 170 of FIG. 1) including at least one sound hole 203, 207, and 214, a sensor module 204 (e.g., the sensor module 176 of FIG. 1), camera modules 205, 212, and 213 (e.g., the camera module 180 of FIG. 1), a key input device 217 (e.g., the input module 150 of FIG. 1), or connector holes 208 and 209 (e.g., the connecting terminal 178 of FIG. 1). In an embodiment, the electronic device 101 may exclude at least one (e.g., the key input device 217 or the light emitting device 206) of the components or may add other components.

According to an embodiment, the display 201 may be visually revealed through, e.g., a majority portion of the front plate 202. In an embodiment, at least a portion of the display 201 may be visually exposed through the front plate 202 forming the first surface 210A, or through a portion of the side surface 210C. In an embodiment, the edge of the display 201 may be configured to be substantially the same in shape as an adjacent outer edge of the front plate 202. In an embodiment (not illustrated), the interval between the outer edge of the display 201 and the outer edge of the front plate 202 may remain substantially even to give a larger area of visual exposure of the display 201.

In an embodiment (not illustrated), the screen display region of the display 201 may have a recess or opening in a portion thereof, and at least one or more of the sound hole 214, sensor module 204, camera module 205, and light emitting device 206 may be aligned with the recess or opening. In an embodiment (not illustrated), at least one or more of the sound hole 214, sensor module 204, camera module 205, fingerprint sensor (not illustrated), and light emitting device 206 may be included on the rear surface of the screen display area of the display 201. In an embodiment (not illustrated), the display 201 may be disposed to be coupled with, or adjacent, a touch detecting circuit, a pressure sensor capable of measuring the strength (pressure) of touches, and/or a digitizer for detecting a magnetic field-type stylus pen. In an embodiment, at least a portion of the sensor module 204 and/or at least a portion of the key input device 217 may be disposed on the side surface 210C.

According to an embodiment, the audio module (not illustrated) may include a microphone hole 203 and sound holes 207 and 214. A microphone for acquiring external sounds may be disposed in the microphone hole 203. In an embodiment, a plurality of microphones may be disposed to detect the direction of the sound. According to an embodiment, the sound holes 207 and 214 may include an external sound hole 207 and a phone receiver hole 214. In an embodiment, the sound holes 207 and 214 and the microphone hole 203 may be implemented as a single hole, or speakers may be included in the audio module without the sound holes 207 and 214 (e.g., piezo speakers).

According to an embodiment, the sensor module 204 may generate an electrical signal or a data value corresponding to an internal operating state of the electronic device 101 or an external environmental state. The sensor module 204 may include, e.g., a first sensor module 204 (e.g., a proximity sensor) and/or a second sensor module (not illustrated) (e.g., a fingerprint sensor) disposed on the front surface 210A of the housing 210. According to an embodiment, an additional sensor module may be disposed on the second surface 210B of the housing 210. The fingerprint sensor (not illustrated) may be disposed on the second surface 210B or side surface 210C as well as the first surface 210A (e.g., the display 201) of the housing 210. The electronic device 101 may further include, e.g., at least one of a gesture sensor, a gyro sensor, an atmospheric pressure sensor, a magnetic sensor, an acceleration sensor, a grip sensor, a color sensor, an infrared (IR) sensor, a biometric sensor, a temperature sensor, a humidity sensor, or an illuminance sensor.

According to an embodiment, the camera modules 205, 212, and 213 may include a first camera module 205 facing the first surface 210A of the electronic device 101, and a second camera module 212 and/or a flash 213 facing the second surface 210B. For example, the first camera module 205 and/or the second camera module 212 may include one or more lenses, an image sensor, and/or an image signal processor. According to an embodiment, some camera module 205 of the camera modules 205 and 212 and/or some sensor module (e.g., the sensor module 204) may be disposed to be exposed to the outside through at least a portion of the display 201. According to an embodiment, the first camera module 205 may include a punch hole camera disposed inside a hole or recess formed in the rear surface of the display 201. For example, the first camera module 205 may receive at least a portion of the light incident on the first surface 210A (or front surface) of the electronic device 101 through the display 201 inside the electronic device 101.

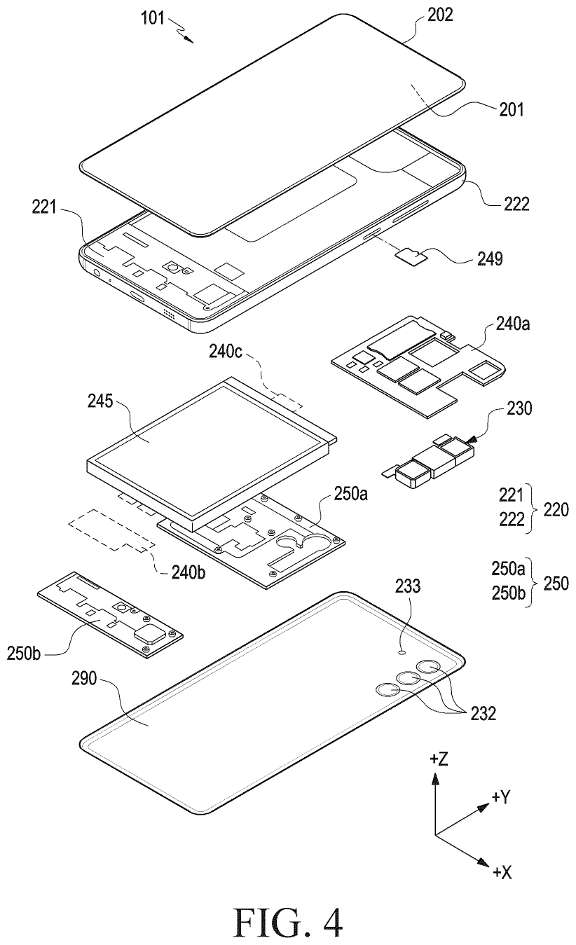

According to an embodiment, the second camera module 212 may be disposed inside the housing 210 so that the lens is exposed to the second surface 210B (or rear surface) of the electronic device 101. For example, the camera module 212 may be electrically connected to the printed circuit board (e.g., the printed circuit board 240a of FIG. 4). For example, the flash 213 may include a light emitting diode or a xenon lamp. In an embodiment, one or more lenses (an infrared (IR) camera, a wide-angle lens, and a telephoto lens) and image sensors may be disposed on one surface of the electronic device 101. In an embodiment, the flash 213 may radiate infrared light. For example, the infrared light radiated from the flash 213 and reflected by the object may be received through the sensor module (not illustrated) disposed on the second surface 210B of the housing 210. The electronic device 101 or the processor (e.g., the processor 180 of FIG. 1) may detect depth information about the subject based on the time point when the infrared light is received from the third sensor module.

According to an embodiment, the key input device 217 may be disposed on the side surface 210C of the housing 210. In an embodiment, the electronic device 101 may exclude all or some of the above-mentioned key input devices 217 and the excluded key input devices 217 may be implemented in other forms, e.g., as soft keys, on the display 201. In an embodiment, the key input device may include the sensor module disposed on the second surface 210B of the housing 210.

According to an embodiment, the light emitting device 206 may be disposed on the first surface 210A of the housing 210, for example. The light emitting device 206 may provide, e.g., information about the state of the electronic device 101 in the form of light. In an embodiment, the light emitting device 206 may provide a light source that interacts with, e.g., the process of the camera module 205. The light emitting device 206 may include, e.g., a light emitting diode (LED), an infrared (IR) LED, or a xenon lamp.

According to an embodiment, the connector holes 208 and 209 may include, e.g., a first connector hole 208 for receiving a connector (e.g., a universal serial bus (USB) connector) for transmitting or receiving power and/or data to/from an external electronic device and/or a second connector hole (e.g., an earphone jack) 209 for receiving a connector for transmitting or receiving audio signals to/from the external electronic device.

FIG. 4 is a front exploded perspective view illustrating an electronic device according to an embodiment of the disclosure.

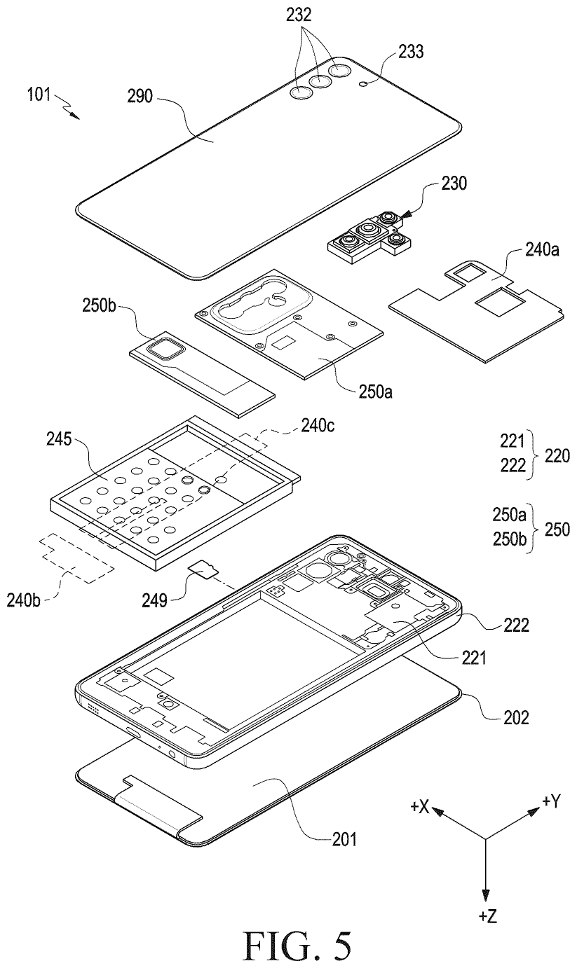

FIG. 5 is a rear exploded perspective view illustrating an electronic device according to an embodiment of the disclosure.

Referring to FIGS. 4 and 5, an electronic device 101 (e.g., the electronic device 101 of FIG. 1 and/or the electronic device 101 of FIG. 2 or 3) includes a display 201 (e.g., the display 201 of FIG. 2), a front plate 202 (e.g., the front plate 202 of FIG. 2), a supporting structure 221 (e.g., a bracket), a side structure (or a side bezel structure) 222, a camera module 230 (e.g., the camera module 180 of FIG. 1), at least one printed circuit board (or board assembly) 240a and 240b, a battery 245 (e.g., the battery 189 of FIG. 1), a storage medium 249, a rear case 250, an antenna (not illustrated) (e.g., the antenna module 197 of FIG. 1), and/or a rear plate 290 (e.g., the rear plate 211 of FIG. 3). According to an embodiment, when the plurality of printed circuit boards 240a and 240b are included, the electronic device 101 may include at least one flexible printed circuit board 240c to electrically connect different printed circuit boards. For example, the printed circuit boards 240a and 240b may include a first circuit board 240a disposed above (e.g., in the +Y-axis direction) the battery 245 and a second circuit board 240b disposed below (e.g., in the −Y-axis direction), and flexible printed circuit board 240c may electrically connect the first circuit board 240a and the second circuit board 240b.

According to an embodiment, the electronic device 101 may omit at least one (e.g., the supporting structure 221, the rear case 250, or the flexible printed circuit board 240c) of the components or may further include other components. At least one of the components of the electronic device 101 may be the same or similar to at least one of the components of the electronic device 101 of FIG. 2 or 3 and no duplicate description is made below.

In an embodiment, at least a portion of the supporting structure 221 may be provided in a flat plate shape. In an embodiment, the supporting structure 221 may be disposed inside the electronic device 101 to be connected to the side structure 222 or may be integrally formed with the side structure 222. For example, the supporting structure 221 may be formed of a conductive material and/or a non-conductive material (e.g., polymer). When the supporting structure 221 at least partially includes a conductive material such as metal, a portion of the side structure 222 or the supporting structure 221 may function as an antenna. The supporting structure 221 may include two surfaces facing in directions opposite to each other. The display 201 may be disposed on one of the two surfaces of the supporting structure 221, and the printed circuit boards 240a and 240b may be disposed on the other surface.

According to an embodiment, the supporting structure 221 and the side structure 222 may be collectively referred to as a front case or a housing 220. For example, a portion of the configuration of the housing 220 may be identical or similar to all or a portion of the configuration of the housing 210 of FIGS. 2 and 3. According to an embodiment, the housing 220 may be generally understood as a structure for receiving, protecting, or disposing electrical/electronic components such as the printed circuit boards 240a and 240b or the battery 245. In an embodiment, the housing 220 may be understood as including a structure that the user may visually or tactfully recognize from the outside of the electronic device 101, e.g., the side structure 222, the front plate 202, and/or the rear plate 290. In an embodiment, the front surface or the rear surface of the housing 220 may refer to the first surface 210A of FIG. 2 or the second surface 210B of FIG. 3. In an embodiment, the supporting structure 221 may be disposed between the front plate 202 (e.g., the first surface 210A of FIG. 2) and the rear plate 290 (e.g., the second surface 210B of FIG. 3), and may function as a structure for disposing electrical/electronic components such as the printed circuit board 240a or 240b or the camera module 230. In the following detailed description, it may be exemplified that the camera module 230 of the electronic device 101 generally includes a configuration for receiving incident light through the second surface 210B of the electronic device 101, but the electronic device 101 may further include a camera module (e.g., the camera module 205 of FIG. 2) and/or a sensor module (e.g., the sensor module 204 of FIG. 2) disposed to be exposed to the outside through at least a portion of the display 201.

According to an embodiment, the camera module 230 may include at least one camera module, e.g., at least one of the plurality of camera modules illustrated in FIGS. 4 and 5. In an embodiment, the camera module 230 may be disposed on a portion of the supporting structure 221 at a position adjacent to the printed circuit boards 240a and 240b. In an embodiment, the camera module 230 may be at least partially surrounded by the rear case 250 (e.g., the upper rear case 250a). According to an embodiment, the camera module 230 may receive at least part of the incident light through the optical hole inside the electronic device 101 or the cover window(s) 232 and 233 disposed on the rear surface (e.g., the second surface 210B of FIG. 3) of the electronic device 101. According to an embodiment, the camera module 230 may be generally aligned with any one of the cover window(s) 232 and 233.

According to an embodiment, a circuit device (e.g., a processor), a communication module (e.g., the communication module 190 of FIG. 1), a power management module (e.g., the power management module 188), memory (e.g., the memory 130 of FIG. 1), an interface (e.g., the interface 177 of FIG. 1), or various electrical/electronic components implemented in the form of an integrated circuit chip may be disposed on the printed circuit board 240a or 240b. The processor (e.g., the processor 120 of FIG. 1) may include one or more of a central processing unit, an application processor, a graphic processing device, an image signal processing, a sensor hub processor, or a communication processor. The memory may include, e.g., a volatile or non-volatile memory. The interface may include, e.g., a high definition multimedia interface (HDMI), a universal serial bus (USB) interface, a secure digital (SD) card interface, and/or an audio interface. The interface may, e.g., electrically or physically connect the electronic device 101 to an external electronic device, and may include a USB connector, an SD card/MMC connector, or an audio connector. According to an embodiment, the printed circuit boards 240a and 240b may be provided with an electromagnetic shielding environment from the rear case 250.

According to an embodiment, the battery 245 may be a device for supplying power to at least one component of the electronic device 101, and may include, e.g., a primary cell which is not rechargeable, a secondary cell which is rechargeable, or a fuel cell. At least a portion of the battery 245 may be disposed on substantially the same plane as the printed circuit board 240a and 240b. The battery 245 may be integrally disposed within the electronic device 101 or may be disposed detachably from the electronic device 101.

According to an embodiment, the storage medium 249 may be detachably provided in the electronic device 101. For example, the storage medium 249 may be attached to or detached from the electronic device 101 through a through hole formed on one side of the housing 220. For example, the storage medium 249 may be a subscriber identification module card (or user authentication module card) or memory card.

According to an embodiment, the rear case 250 may include an upper rear case 250a and a lower rear case 250b. In an embodiment, the upper rear case 250a may be disposed to surround the printed circuit boards 240a and 240b (e.g., the first circuit board 240a), together with a portion of the supporting structure 221. For example, the upper rear case 250a may be disposed to face the supporting structure 221 with the first circuit board 240a interposed therebetween.

In an embodiment, the lower rear case 250b may be utilized as a structure in which electrical/electronic components, such as an interface (e.g., a USB connector, an SD card/MMC connector, or an audio connector) may be disposed. According to an embodiment, electrical/electronic components, such as an interface (e.g., a USB connector, an SD card/MMC connector, or an audio connector) may be disposed on an additional printed circuit board (not illustrated). In this case, the lower rear case 250b, together with the other part of the supporting structure 221, may be disposed to surround the additional printed circuit board (not illustrated). For example, an interface disposed in an additional printed circuit board not illustrated or the lower rear case 250b may be disposed corresponding to the sound hole 207 or the connector holes 208 and 209 of FIG. 2.

According to an embodiment, the antenna (not illustrated) may include, e.g., a conductor pattern implemented on the surface of the rear case 250 through a laser direct structuring method. In an embodiment, the antenna may include a printed circuit pattern formed on the surface of the thin film. The thin film-type antenna may be disposed between the rear plate 290 and the battery 245. The antenna may include, e.g., a near-field communication (NFC) antenna, a wireless charging antenna, and/or a magnetic secure transmission (MST) antenna. The antenna may perform short-range communication with, e.g., an external device or may wirelessly transmit or receive power necessary for charging. In an embodiment, another antenna structure may be formed by a part or a combination of the supporting structure 221 and/or the side structure 222.

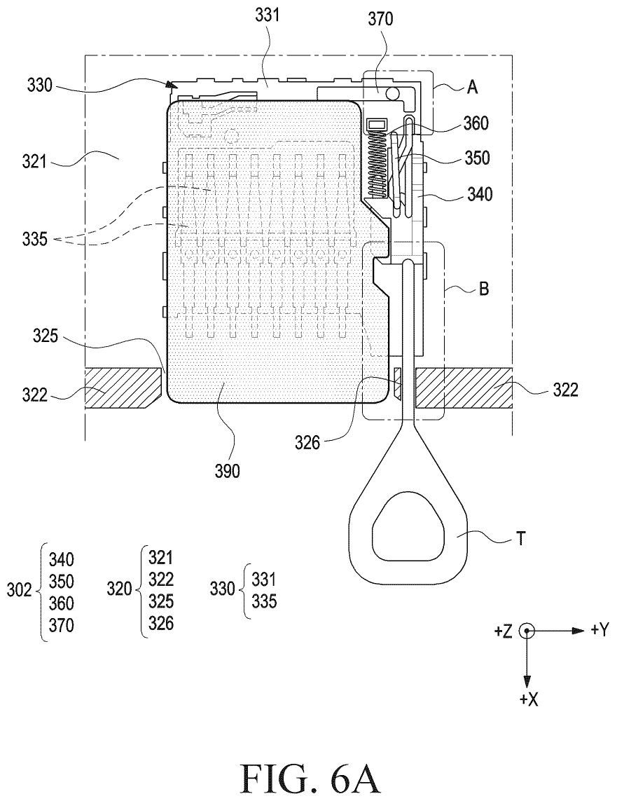

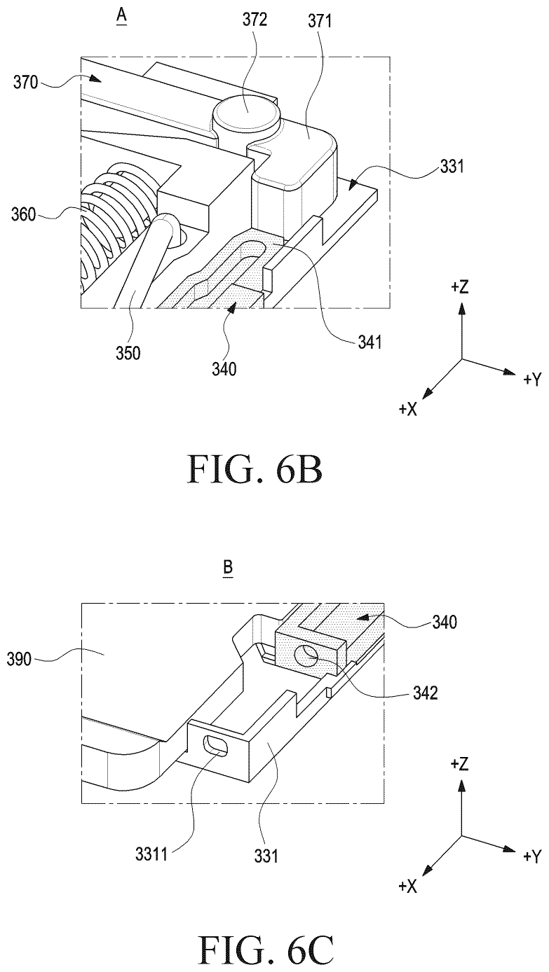

FIG. 6A is a plan view illustrating a state in which a storage medium is mounted in a socket, according to an embodiment of the disclosure.

FIG. 6B is an enlarged view illustrating portion A of FIG. 6A, according to an embodiment of the disclosure.

FIG. 6C is an enlarged view illustrating portion B of FIG. 6A, according to an embodiment of the disclosure.

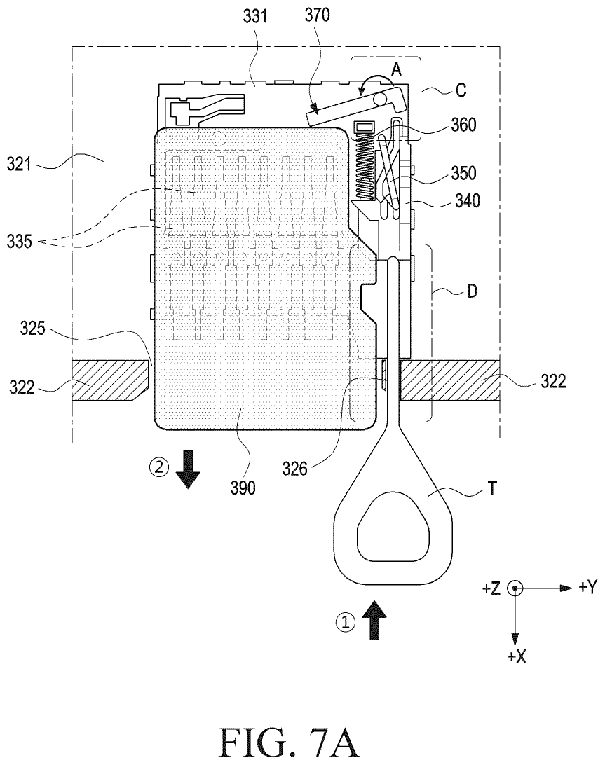

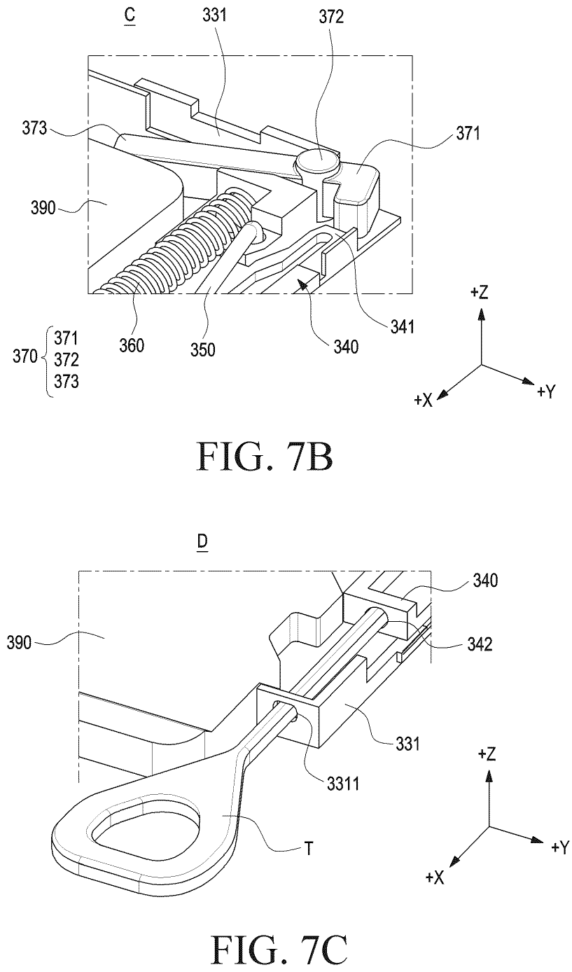

FIG. 7A is a plan view illustrating a state in which a storage medium is discharged from a socket, according to an embodiment of the disclosure.

FIG. 7B is an enlarged view illustrating portion C of FIG. 7A, according to an embodiment of the disclosure.

FIG. 7C is an enlarged view illustrating portion D of FIG. 7A, according to an embodiment of the disclosure.

Referring to FIGS. 6A to 6C and 7A to 7C, in an embodiment, an electronic device (e.g., the electronic device 101 of FIGS. 1 to 5) may include a housing 320 (e.g., the housing 210 of FIGS. 2 and 3 and the housing 220 of FIGS. 4 and 5) and a connector 330 and a locking structure 302 disposed within the housing 320 and configured to receive a storage medium 390 (e.g., the storage medium 249 of FIGS. 4 and 5). For example, the storage medium 390 may include a subscriber identification module card (or user authentication module card) or memory card.

According to an embodiment, the connector 330 of the electronic device 101 may include a socket 331 in which the storage medium 390 is disposed and terminal pins 335 to which the storage medium 390 is connected. According to an embodiment, the locking structure 302 of the electronic device 101 may be configured to fix or hold the storage medium 390 to the socket 331 or to separate or discharge it from the socket 331.

According to an embodiment, the housing 320 of the electronic device 101 may include a supporting structure 321 (e.g., the supporting structure 221 of FIGS. 4 and 5) disposed inside the electronic device 101 and a side structure 322 (e.g., the side structure 222 of FIGS. 4 and 5) disposed around the supporting structure 321 and connected to or integrally formed with the supporting structure 321.

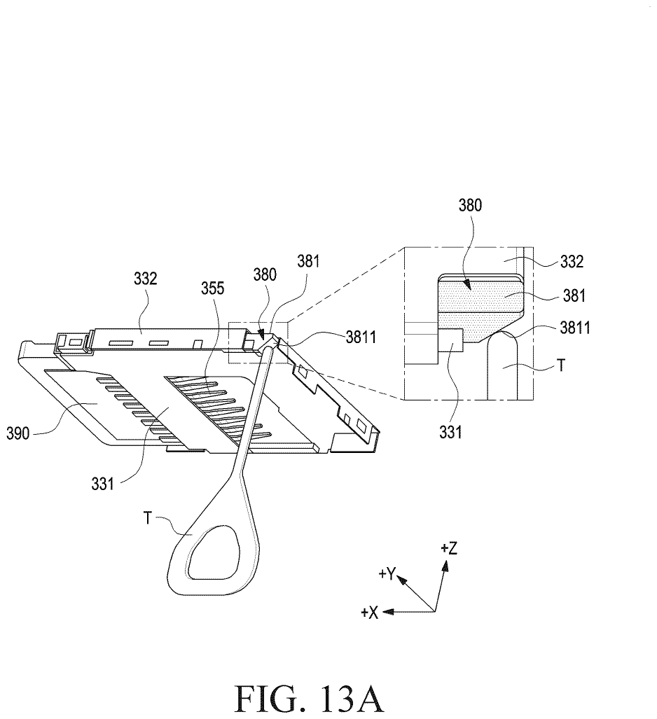

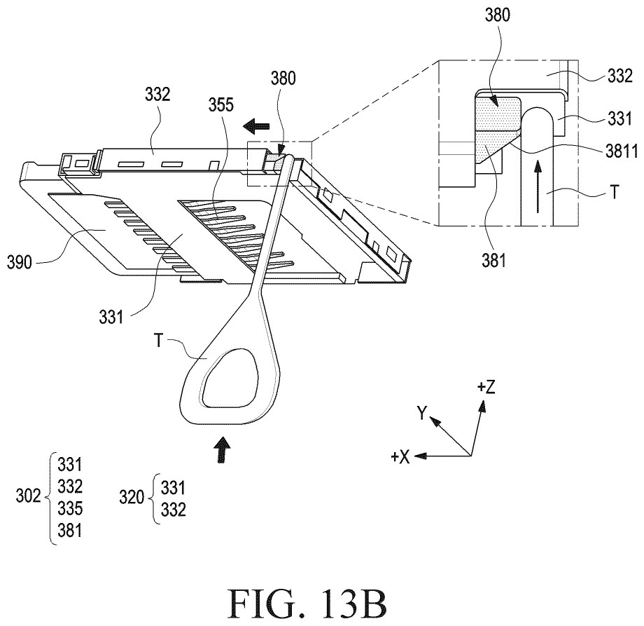

According to an embodiment, through hole(s) 325, 326 for inserting or discharging the storage medium 390 and/or the push-tool T may be formed in the side structure 322 of the housing 320. According to an embodiment, a first through hole 325 configured for the storage medium 390 to pass through and a second through hole 326 configured for the push-tool T to pass through may be included in the side structure 322. For example, the first through hole 325 and the second through hole 326 may be formed in the side structure 322 and may be spaced apart from each other. In the disclosure, positions of the first through hole 325 and the second through hole 326 may be changed. According to an embodiment, a through hole configured for the push-tool T to pass through (e.g., the second through hole 326 of FIG. 6A and/or the third through hole 329a of FIG. 13) may be formed in a rear plate (e.g., the rear plate 290 of FIGS. 4 and 5 and the rear plate 329 of FIG. 13) that substantially forms the rear surface (e.g., the second surface 210B of FIG. 3) of the electronic device 101.

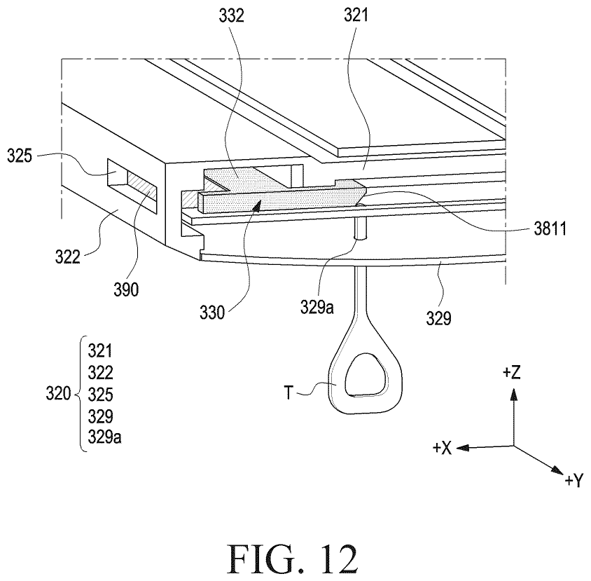

According to an embodiment, the socket 331 may be configured to seat the storage medium 390 inserted through the first through hole 325. For example, the socket 331 may be disposed or connected to the supporting structure 321 of the housing 320 on an inner side of the side structure 322 of the housing 320. For example, the connector 330 may further include a cover shell (e.g., the cover shell 332 of FIGS. 12A and 12B) for forming an accommodation space where the storage medium 390 is disposed together with the socket 331. For example, the storage medium 390 may be inserted into the socket 331 in a first direction, e.g., a −X direction with respect to FIG. 6A, and discharged in a second direction opposite to the first direction, e.g., a +X direction with respect to FIG. 6A.

In an embodiment, the locking structure 302 may be disposed and/or connected to the socket 331. The locking structure 302 may be configured to fix the storage medium 390 inserted into the socket 331 or discharge it from the socket 331. Referring to FIGS. 6A to 6C and 7A to 7C, according to an embodiment, the locking structure 302 may include an operation cam 340 movably provided with the storage medium 390, a locking bar 350 configured to allow or restrict movement of the operation cam 340, and a release lever 370 (eject lever) (or emergency lever). According to an embodiment, the locking structure 302 may further include an elastic member 360 providing an elastic force to the operation cam 340.

According to an embodiment, the locking structure 302 may provide a structure for mounting by pushing (e.g., push-in) the storage medium 390 toward the socket 331 (in a −X direction with respect to FIG. 6A) and discharging by pushing (e.g., push-pull). The locking structure 302 may provide a structure for discharging the storage medium 390 by inserting the push-tool T into the socket 331. For example, the operation cam 340, the locking bar 350, and the elastic member 360 may together constitute a “push-in and push-pull structure.”

According to an embodiment, an “emergency release structure” of the locking structure 302 may be implemented by adding the release lever 370 to the above-described “push-in and push-pull structure.” According to an embodiment, the storage medium 390 received in the socket 331 may be discharged to the outside of the electronic device (e.g., the electronic device 101 of FIGS. 1 to 5) through the first through hole 325 of the housing 320 based on movement of the operation cam 340 based on the elastic force of the elastic member 360 or pressing force of the release lever 370.

According to an embodiment, operation of the “push-in and push-pull structure” due to pressing force for insertion or release of the storage medium 390 may operate normally separately from or independently of operation of the “emergency release structure” due to pressing force by the push-tool T.

FIGS. 6A to 6C may show a state in which the storage medium 390 is completely mounted in the socket 331, and FIGS. 7A to 7C may show discharging the storage medium 390 by rotating the release lever 370 using the push-tool T. For example, the locking structure 302 may be configured to forcibly discharge the storage medium 390 using the release lever 370 and the push-tool T constituting the “emergency release structure” when unable to discharge it from the socket 331 with the push-pull structure due to structural jamming of the storage medium 390 with respect to the socket 331 or friction between the storage medium 390 and the socket 331. In other words, according to an embodiment, the locking structure 302 may enable self-repair by a user with a simple operation of forcibly releasing the storage medium 390 using the push-tool T without needing to disassemble or dismantle the locking structure 302 when unable to discharge the storage medium 390 from the socket 331 with the push-pull structure.

Referring to FIGS. 6B and 7B, in an embodiment, the operation cam 340 of the locking structure 302 may include a protrusion 341 for pressing a portion (e.g., the first end 371) of the release lever 370. Referring to FIGS. 6C and 7C, according to an embodiment, the operation cam 340 may include a seating area 342 contacted by the push-tool T inserted through the second through hole (e.g., the second through hole 326 of FIG. 6A) of the housing 320. For example, the seating area 342 may be in the form of a recess configured to receive an end of the push-tool T. Referring to FIGS. 6C and 7C, according to an embodiment, the socket 331 may include a guide hole 3311 through which the push-tool T inserted through the second through hole (e.g., the second through hole 326 of FIG. 6A) of the housing 320 passes. For example, the second through hole 326, the guide hole 3311 of the socket 331, and/or the seating area 342 of the operation cam 340 may at least partially overlap each other when viewed in one axial direction (e.g., X axis) and may be aligned with each other with respect to the one axis (e.g., X axis).

According to an embodiment, the release lever 370 may include a first end 371 disposed to be contactable with the operation cam 340, a second end 373 disposed to be contactable with the storage medium 390, and a rotational shaft 372 disposed between the first end 371 and the second end 373. According to an embodiment, the release lever 370 may be pivotally rotatably connected to the socket 331 and, e.g., may rotate about the rotational shaft 372.

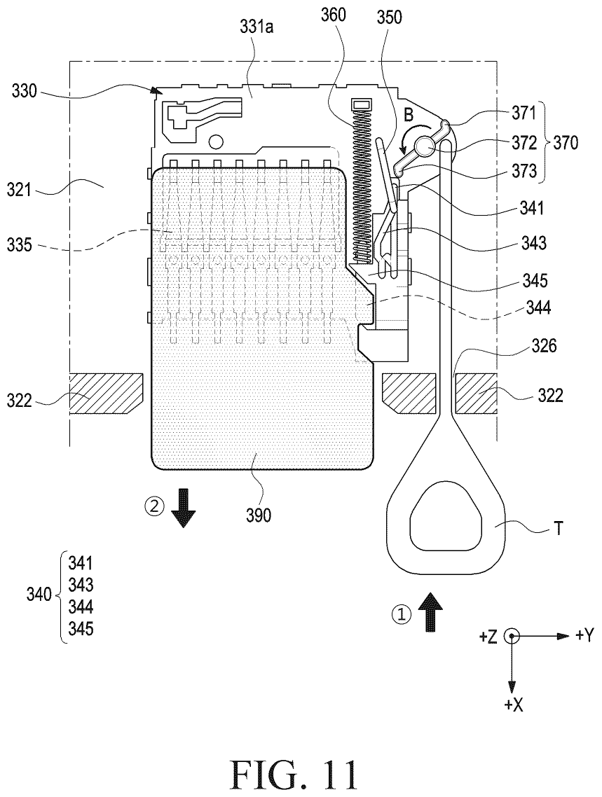

Referring to FIGS. 7A to 7C, the operation cam 340 may be pressed in a direction in which the storage medium 390 is inserted into the socket 331 by the push-tool T with a portion (e.g., the seating area 342) inserted into the guide hole 3311 of the socket 331. For example, the push-tool T may be inserted inside the socket 331 through the second through hole 326 formed in the side structure 322 of the housing 320. For example, the direction in which the storage medium 390 is inserted into the socket 331 may be referred to as a first direction (e.g., arrow \textcircled{1} direction of FIG. 11 or −X direction). Another portion of the operation cam 340 (e.g., the protrusion 341) may push the first end 371 of the release lever 370 in the first direction based on the pressing force of the push-tool T. The release lever 370 may be rotated based on the pressing force of the operation cam 340, and the second end 373 may push the storage medium 390 in a direction to be discharged from the socket 331. For example, the direction in which the operation cam 340 discharges the storage medium 390 from the socket 331 may be referred to as a second direction opposite to the first direction (e.g., arrow \textcircled{2} direction of FIG. 11 or +X direction). For example, the release lever 370 may be rotated in the arrow A direction of FIG. 7A with respect to the rotational shaft 372.

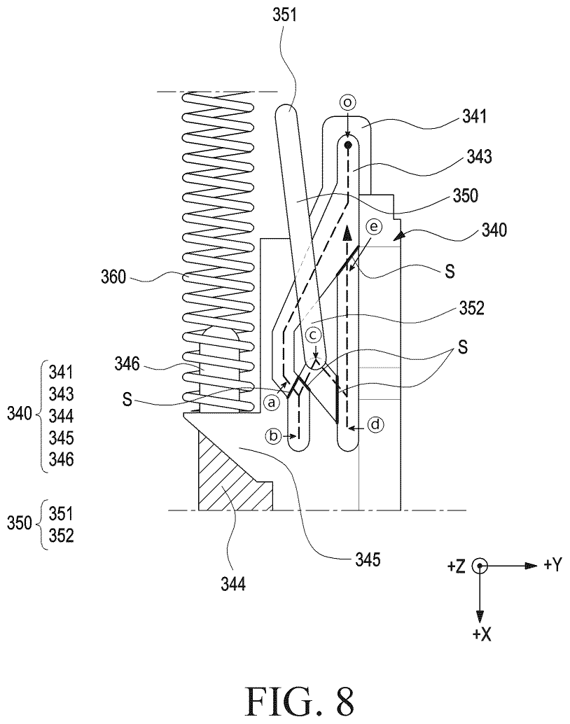

FIG. 8 is a plan view illustrating operation of a locking bar of a locking structure, according to an embodiment of the disclosure.

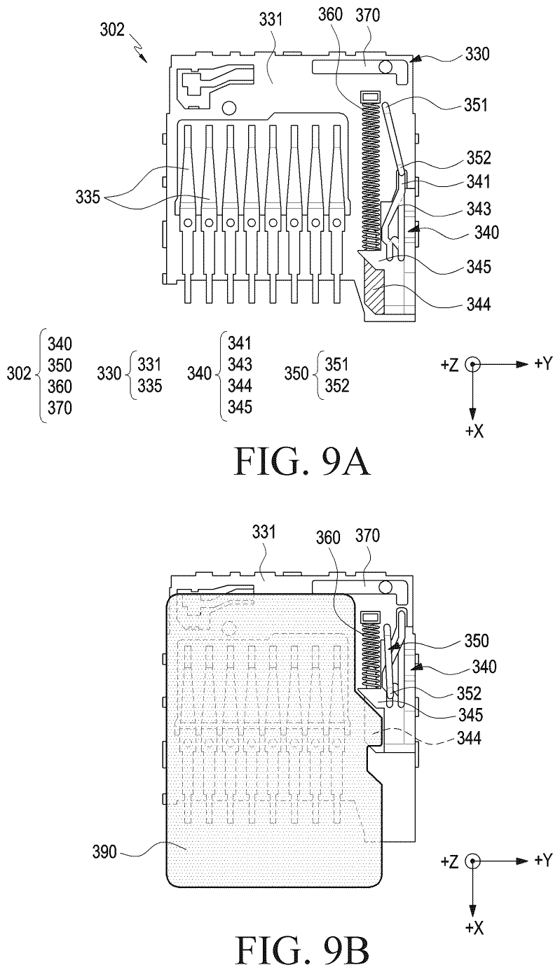

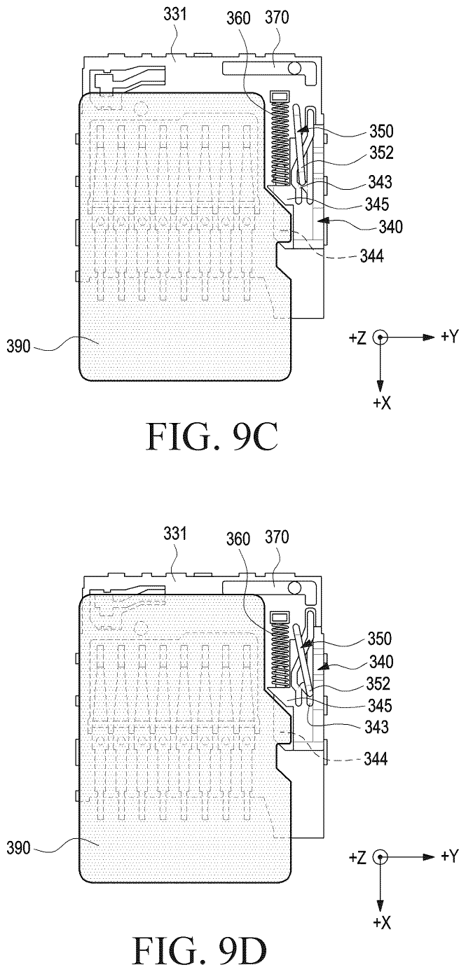

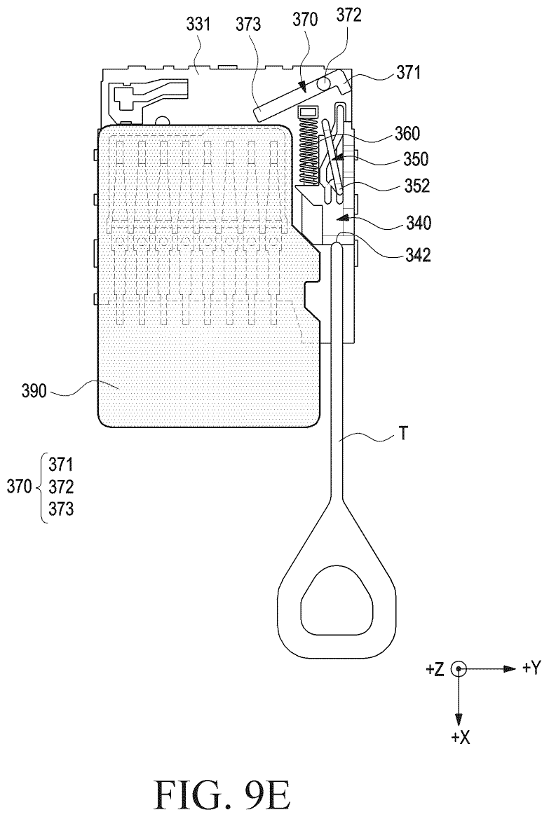

FIGS. 9A to 9E are plan views illustrating an operation of mounting a storage medium in a socket and an operation of discharging a socket using a locking lever, according to various embodiments of the disclosure.

Referring to FIG. 8, according to an embodiment, the operation cam 340 of the locking structure 302 may include a protrusion 341, a guide recess 343, a seating area 344, a stepped portion 345, and/or a guide portion 346. According to an embodiment, the locking bar 350 of the locking structure 302 may include a first bar end 351 providing a rotation axis and a second bar end 352 sliding within the guide recess 343 of the operation cam 340. For example, the locking bar 350 may be configured to pivot about the first bar end 351 or a rotation axis to which the first bar end 351 is connected.

According to an embodiment, in a process in which the storage medium 390 is mounted in the socket 331 and separated from the socket 331, the second bar end 352 of the locking bar 350 may move between position \textcircled{o}, position \textcircled{a}, position \textcircled{b}, position \textcircled{c}, position \textcircled{d}, position \textcircled{e}, and position \textcircled{o} of the guide recess 343 of the operation cam 340. As an example, the locking bar 350 may fix or hold the storage medium 390 to the socket 331 by fixing the operation cam 340 when the second bar end 352 is at position \textcircled{c}.

According to an embodiment, a portion of the storage medium 390 may be seated in the seating area 344 of the operation cam 340. According to an embodiment, the stepped portion 345 may function as a stopper limiting movement of the storage medium 390 in the first direction (e.g., −X direction). According to an embodiment, the elastic member 360 may be disposed around the guide portion 346 of the operation cam 340 according to the position of the operation cam 340. The elastic member 360 may provide an elastic force pushing the operation cam 340 in the second direction (e.g., +X direction) in which the storage medium 390 is discharged.

Referring to FIGS. 9A to 9E, operation of the locking structure 302 for mounting the storage medium 390 in the socket 331 and separating the storage medium 390 from the socket 331 using the release lever 370 and the push-tool T is described. The locking structure 302 of FIGS. 9A to 9E may be referred to as the locking structure 302 of FIGS. 6A and 7A, and the operation cam 340 of FIGS. 9A to 9E may be referred to as the operation cam 340 of FIGS. 6A to 6C, 7A to 7C. and 8.

FIG. 9A may show the appearance of the socket 331 before the storage medium 390 is mounted, and in this case, the second bar end 352 of the locking bar 350 may be disposed at position \textcircled{o} of the guide recess 343 of the operation cam 340. While inserting the storage medium 390 into the socket 331, the second bar end 352 of the locking bar 350 may be disposed at position \textcircled{o}, position \textcircled{a}, or between position \textcircled{o} and position \textcircled{a} of the guide recess 343 of the operation cam 340 of FIG. 8. When the storage medium 390 is completely or maximally inserted into the socket 331, the second bar end 352 may move from position \textcircled{a} to position \textcircled{b}.

FIG. 9B may show a state in which the storage medium 390 is completely inserted into the socket 331, and in this case, the second bar end 352 of the locking bar 350 may be disposed at position \textcircled{b} or around position \textcircled{b} of the guide recess 343 of the operation cam 340 of FIG. 8. For example, a user may push the storage medium 390 into the socket 331 in the first direction (e.g., −X direction) through the first through hole (e.g., the first through hole 325 of FIG. 6A). A step S may be present between position \textcircled{a} and position \textcircled{b} of the guide recess 343. The step S may be formed so that position \textcircled{b} is lower than position \textcircled{a}, and due to the step S, the second bar end 352 may not be able to move backward from position \textcircled{b} to position \textcircled{a}.

FIG. 9C may show a state in which the storage medium 390 is fixed or held within the socket 331 as the operation cam 340 is fixed by the locking bar 350 after the storage medium 390 is completely inserted into the socket 331. In this case, the second bar end 352 of the locking bar 350 may be disposed at position \textcircled{c} of the guide recess 343 of the operation cam 340 of FIG. 8. For example, when the force pushing the storage medium 390 inside the socket 331 or in the first direction (e.g., −X direction) is removed, the operation cam 340 may move in the second direction (e.g., +X direction) due to the elastic force of the elastic member 360, and the second bar end 352 may move from position \textcircled{b} to position \textcircled{c}. A step S may be present between position \textcircled{b} and position \textcircled{c} of the guide recess 343. The step S may be formed so that position \textcircled{c} is lower than position \textcircled{b}, and due to the step S, the second bar end 352 may not be able to move backward from position \textcircled{c} to position \textcircled{b}.

As described above with reference to FIGS. 9A to 9C, according to an embodiment, the locking structure 302 may provide a push-in structure for mounting by pushing the storage medium 390 into the socket 331.

According to an embodiment, the locking structure 302 may provide a push-pull structure for discharging by pushing the storage medium 390 into the socket 331. For example, when the storage medium 390 in the state illustrated in FIG. 9D is pushed inside the socket 331 or in the first direction (e.g., −X direction), the second bar end 352 of the locking bar 350 may move from position \textcircled{c} of the guide recess 343 of the operation cam 340 of FIG. 8 to position \textcircled{d} of the guide recess 343. For example, when the force pushing the storage medium 390 inside the socket 331 or in the first direction (e.g., −X direction) is removed, the operation cam 340 may move in the second direction (e.g., +X direction) due to the elastic force of the elastic member 360, and the second bar end 352 may move from position \textcircled{d} to position \textcircled{o} through position \textcircled{e}. A step S may be present between position \textcircled{c} and position \textcircled{d} of the guide recess 343. The step S may be formed so that position \textcircled{d} is lower than position \textcircled{c}, and due to the step S, the second bar end 352 may not be able to move backward from position \textcircled{d} to position \textcircled{c}. For example, when the storage medium 390 is completely removed from the socket 331, the second bar end 352 may move from position \textcircled{c} of the guide recess 343 of the operation cam 340 of FIG. 8 to position \textcircled{o} through position \textcircled{d} and position \textcircled{e}. A step S for limiting backward movement of the second bar end 352 from position \textcircled{o} to position \textcircled{e} may be present between position \textcircled{e} and position \textcircled{o} of the guide recess 343.

For example, according to the push-in and push-pull structure of the locking structure 302 described above, a phenomenon may occur in which the storage medium 390 becomes jammed in the socket 331 so that the locking bar 350 and the operation cam 340 may not operate normally. For example, due to friction between the storage medium 390 and the socket 331 during insertion of the storage medium 390 into the socket 331, the second bar end 352 may not be able to move from position \textcircled{b} to position \textcircled{c}, from position \textcircled{d} to \textcircled{e}, or from position \textcircled{e} to position \textcircled{o} of the guide recess 343 of FIG. 8. When the storage medium 390 is jammed in the socket 331, the storage medium 390 may be discharged using the push-tool T as illustrated in FIG. 9E.

Referring to FIG. 9E, the operation cam 340 may be pressed in the first direction (e.g., arrow \textcircled{1} direction of FIG. 7A or −X direction) by the push-tool T. The second end 373 of the release lever 370 may push the storage medium 390 in the second direction opposite to the first direction (e.g., arrow \textcircled{2} direction of FIG. 7A or +X direction) by being rotated based on the pressing force of the operation cam 340, and the storage medium 390 may be discharged from the socket 331. For example, the push-tool T may be inserted inside the socket 331 through the second through hole (e.g., the first through hole 326 of FIG. 6A) of the housing (e.g., the housing 320 of FIG. 6A) and the guide hole (e.g., the guide hole 3311 of FIG. 6C) of the socket 331.

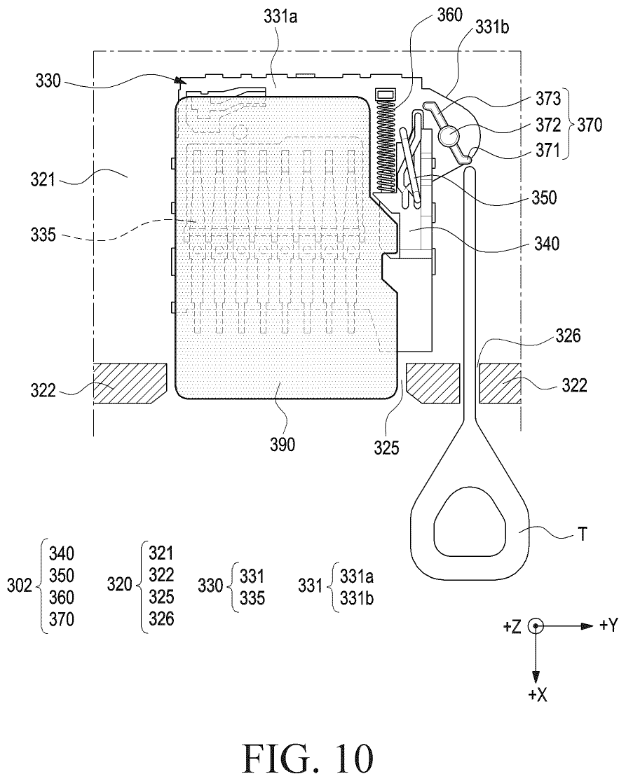

FIG. 10 is a plan view illustrating a state in which a storage medium is mounted in a socket, according to an embodiment of the disclosure.

FIG. 11 is a plan view illustrating a state in which a storage medium is discharged from a socket, according to an embodiment of the disclosure.

The configuration of the locking structure 302 of FIGS. 10 and 11 may be the same as a portion of the configuration of the locking structure 302 of FIGS. 6A, 7A, and 9A to 9E. The embodiment of FIGS. 10 and 11 may differ from the embodiment of FIGS. 6A to 6C, 7A to 7C, 8, and 9A to 9E in the form and arrangement of the release lever 370. The embodiment of FIGS. 10 and 11 may be substantially the same as the embodiment of FIGS. 6A to 6C, 7A to 7C, 8, and 9A to 9E except for the remaining configuration of the locking structure 302 excluding the release lever 370 (e.g., the operation cam 340, the locking bar 350, and the elastic member 360). Hereinafter, the embodiment of FIGS. 10 and 11 may be described focusing on differences from the embodiment of FIGS. 6A to 6C, 7A to 7C, 8, and 9A to 9E, and the above-described content may not be duplicated.

FIG. 10 illustrates a state in which the storage medium 390 is completely mounted in the socket 331, and FIG. 11 may show discharging the storage medium 390 by rotating the release lever 370 using the push-tool T.

According to an embodiment, the socket 331 may include a first region 331a where the storage medium 390 and the operation cam 340, the locking bar 350, and the elastic member 360 of the locking structure 302 are disposed, and a second region 331b where the release lever 370 is disposed and located around the first region 331a. According to an embodiment, at least a portion of the operation cam 340 may be disposed between the release lever 370 and the elastic member 360. According to an embodiment, the release lever 370 may include a first end 371 disposed to be contactable with the push-tool T, a second end 373 disposed to be contactable with the operation cam 340, and a rotational shaft 372 disposed between the first end 371 and the second end 373. According to an embodiment, the release lever 370 may be pivotally rotatably connected to the socket 331 and, e.g., may rotate about the rotational shaft 372.

Referring to FIGS. 10 and 11, according to an embodiment, the first end 371 of the release lever 370 may be pressed in a direction in which the storage medium 390 is inserted into the socket 331 by the push-tool T inserted inside the socket 331. For example, the push-tool T may be inserted inside the socket 331 through the second through hole 326 formed in the side structure 322 of the housing 320. For example, the direction in which the storage medium 390 is inserted into the socket 331 may be referred to as a first direction (e.g., arrow \textcircled{1} direction of FIG. 11 or −X direction).

According to an embodiment, the release lever 370 may be rotated based on the pressing force of the push-tool T. For example, the release lever 370 may be rotated in the arrow B direction of FIG. 11 with respect to the rotational shaft 372. The second end 373 of the release lever 370 may push the operation cam 340 in a direction to discharge the storage medium 390 from the socket 331. For example, the direction in which the operation cam 340 discharges the storage medium 390 from the socket 331 may be referred to as a second direction opposite to the first direction (e.g., arrow \textcircled{2} direction of FIG. 11 or +X direction). The storage medium 390 may be discharged to the outside of the socket 331, the housing 320, or the electronic device (e.g., the electronic device of FIGS. 1 to 5) together with the operation cam 340. According to an embodiment, the storage medium 390 may be caught on the stepped portion 345 of the operation cam 340 and moved together with the operation cam 340.

FIG. 12 is a perspective view illustrating insertion of a push-tool into an electronic device, according to an embodiment of the disclosure.

FIG. 13A is a perspective view illustrating a state in which a storage medium is mounted in a socket, according to an embodiment of the disclosure.

FIG. 13B is a perspective view illustrating a state in which a storage medium is discharged from a socket, according to an embodiment of the disclosure.

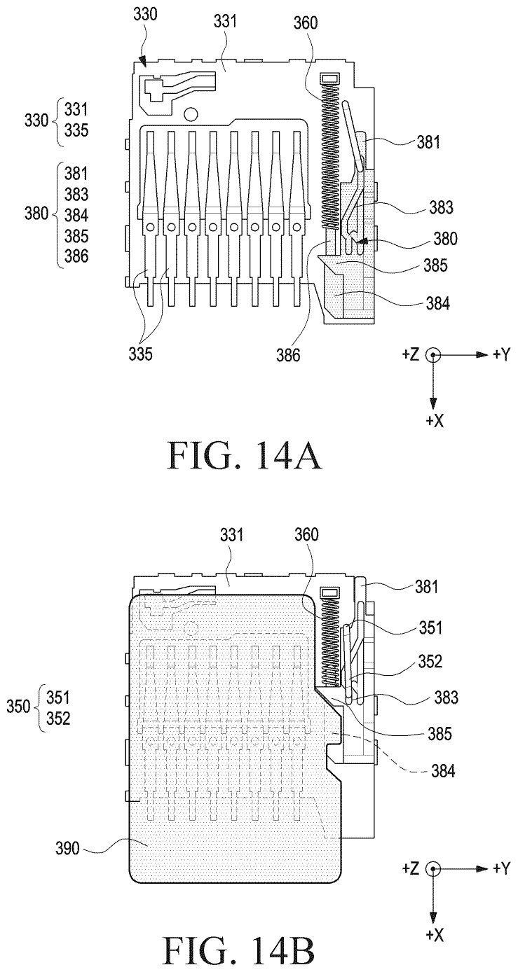

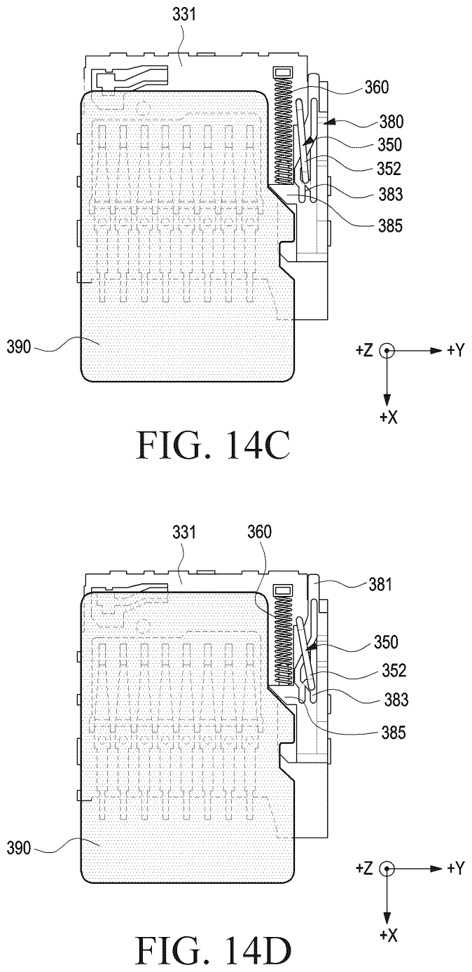

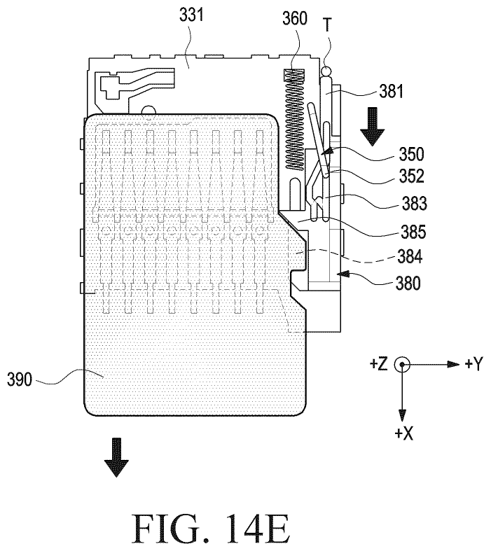

FIGS. 14A, 14B, 14C, 14D, and 14E are plan views illustrating an operation of mounting a storage medium in a socket and an operation of discharging a socket using a push-tool, according to various embodiments of the disclosure.

The configuration of the locking structure 302 of FIGS. 12, 13A, 13B, and 14A may be the same as a portion of the configuration of the locking structure 302 of FIGS. 6A, 7A, 9A to 9E, 10, and 11. The embodiment of FIGS. 12, 13A, 13B, and 14A to 14E may at least partially differ in the form of the operation cam 380 of the locking structure 302 from the form of the operation cam 340 of the embodiment of FIGS. 6A to 11. The locking bar 350 and the elastic member 360 of the locking structure 302 of the embodiment of FIGS. 12, 13A, 13B, and 14A may be referred to as the locking bar 350 and the elastic member 360 of FIGS. 6A to 6C, 7A to 7C, 8, 9A to 9E, 10, and 11. Hereinafter, the embodiment of FIGS. 12, 13A, 13B, and 14A to 14E may be described focusing on differences from the embodiment of FIGS. 6A to 6C, 7A to 7C, 8, 9A to 9E, 10, and 11, and the above-described content may not be duplicated.

Referring to FIG. 12, in an embodiment, an electronic device (e.g., the electronic device 101 of FIGS. 1 to 5) may include a housing 320 (e.g., the housing 210 of FIGS. 2 and 3 and the housing 220 of FIGS. 4 and 5) and a connector 330 and a locking structure 302 disposed within the housing 320 and configured to receive a storage medium 390. For example, the storage medium 390 may include a subscriber identification module card (or user authentication module card) or memory card.

Referring to FIG. 12, according to an embodiment, the housing 320 of the electronic device 101 may include a supporting structure 321 (e.g., the supporting structure 221 of FIGS. 4 and 5) disposed inside the electronic device 101, and a side structure 322 (e.g., the side structure 222 of FIGS. 4 and 5) disposed around the supporting structure 321 and connected to or integrally formed with the supporting structure 321. The housing 320 may include a rear plate 329 (e.g., the rear plate 290 of FIGS. 4 and 5) forming the rear surface (e.g., the second surface 210B of FIG. 3) of the electronic device 101.

According to an embodiment, through hole(s) 325, 329a for inserting or discharging the storage medium 390 and/or the push-tool T may be formed in the supporting structure 321, the side structure 322, and/or the rear plate 329 of the housing 320. According to an embodiment, a first through hole 325 configured for the storage medium 390 to pass through and a second through hole 329a configured for the push-tool T to pass through may be included in the side structure 322. According to an embodiment, the first through hole 325 may be formed in the side structure 322, and the second through hole 329a may be formed in the rear plate 329.

Referring to FIGS. 13A and 13B, the connector 330 may include a socket 331 in which the storage medium 390 is disposed, terminal pins 335 to which the storage medium 390 is connected, and a cover shell 332. According to an embodiment, the socket 331 may be configured to seat the storage medium 390 inserted through the first through hole 325. For example, the socket 331 may be disposed or connected to the supporting structure 321 of the housing 320 on an inner side of the side structure 322 of the housing 320. For example, the socket 331 may form an accommodation space where the storage medium 390 is disposed together with the cover shell 332. For example, the storage medium 390 may be inserted into the socket 331 in a first direction, e.g., a −X direction with respect to FIG. 13A, and discharged in a second direction opposite to the first direction, e.g., a +X direction with respect to FIG. 13A.

In an embodiment, the locking structure 302 may be configured to fix or hold the storage medium 390 to the connector 330 or to separate or discharge it from the connector 330. Referring to FIGS. 14A to 14E, according to an embodiment, the locking structure 302 may include an operation cam 380 movably provided with the storage medium 390, a locking bar 350 configured to allow or restrict movement of the operation cam 380, and/or an elastic member 360 connected to the operation cam 380.

According to an embodiment, the locking structure 302 may provide a structure for mounting by pushing (e.g., push-in) the storage medium 390 into the socket 331 and discharging by pushing (e.g., push-pull). The locking structure 302 may provide a structure for discharging the storage medium 390 by inserting the push-tool T into the socket 331. For example, the operation cam 380, the locking bar 350, and the elastic member 360 may together constitute a push-in and push-pull structure. For example, the emergency release structure of the locking structure 302 may be implemented by forming an inclined surface 3811 at one end of the operation cam 380. According to an embodiment, the storage medium 390 received in the socket 331 may be discharged to the outside of the electronic device (e.g., the electronic device 101 of FIGS. 1 to 5) through the first through hole 325 of the housing 320 according to movement of the operation cam 380 based on the elastic force of the elastic member 360 or the pressing force of the push-tool T.

FIG. 13A illustrates a state in which the storage medium 390 is completely mounted in the socket 331, and FIG. 13B may show moving the operation cam 380 using the push-tool T to discharge the storage medium 390. For example, the locking structure 302 may be configured to enable forced discharge of the storage medium 390 using the push-tool T when unable to discharge it from the socket 331 with the push-pull structure due to structural jamming of the storage medium 390 with respect to the socket 331 or friction between the storage medium 390 and the socket 331. The locking structure 302 according to an embodiment may enable self-repair using the push-tool T by a user when unable to discharge it from the socket 331 with the push-pull structure.

Referring to FIGS. 13A and 13B, in an embodiment, the operation cam 380 of the locking structure 302 may include a protrusion 381 and an inclined surface 3811 formed at an end of the protrusion 381. According to an embodiment, the inclined surface 3811 may face the second through hole 320a in a state in which the storage medium 390 is disposed in the socket 331. According to an embodiment, the inclined surface 3811 of the operation cam 380 may be pressed by the push-tool T in a third direction (e.g., +Z direction) that intersects a first direction (e.g., −X direction) in which the storage medium 390 is inserted into the socket 331 and a second direction (e.g., +X direction) opposite to the first direction. According to an embodiment, when the inclined surface 3811 is pressed in the third direction (e.g., +Z direction) by the push-tool T, the entire operation cam 380 may be configured to move in the second direction (e.g., +X direction). According to an embodiment, when the operation cam 380 is moved in the second direction (e.g., +X direction), the storage medium 390 may be moved in the second direction (e.g., +X direction) by the operation cam 380 and discharged to the outside of the electronic device (e.g., the electronic device 101 of FIGS. 1 to 5). In the disclosure, the shape of the inclined surface 3811 is merely an example, and the shape of the inclined surface 3811 may be any form that may convert the pressing force of the push-tool T into movement of the operation cam 380 in the second direction (e.g., +X direction).

Referring to FIGS. 14A to 14E, according to an embodiment, the operation cam 380 of the locking structure 302 may include a protrusion 381, a guide recess 383, a seating area 384, a stepped portion 385, and/or a guide portion 346. According to an embodiment, the locking bar 350 of the locking structure 302 may include a first bar end 351 providing a rotation axis and a second bar end 352 sliding within the guide recess 383 of the operation cam 340. According to an embodiment, in a process in which the storage medium 390 is mounted in the socket 331 and separated from the socket 331, the second bar end 352 of the locking bar 350 may move along a path (e.g., position \textcircled{o}, position \textcircled{a}, position \textcircled{b}, position \textcircled{c}, position \textcircled{d}, and position \textcircled{e} of FIG. 8) of the guide recess 383 of the operation cam 380.

According to an embodiment, a portion of the storage medium 390 may be seated in the seating area 384 of the operation cam 380. According to an embodiment, the stepped portion 385 may function as a stopper limiting movement of the storage medium 390 in the first direction (e.g., −X direction). According to an embodiment, the elastic member 360 may be disposed around the guide portion 346 of the operation cam 340 according to the position of the operation cam 340. The elastic member 360 may provide an elastic force pushing the operation cam 380 in the second direction (e.g., +X direction) in which the storage medium 390 is discharged.

FIG. 14A may show the appearance of the socket 331 before the storage medium 390 is mounted. FIG. 14B may show a state in which the storage medium 390 is maximally or completely inserted into the socket 331. FIG. 14C may show a state in which the storage medium 390 is fixed or held within the socket 331 as the operation cam 340 is fixed by the locking bar 350 after the storage medium 390 is completely inserted into the socket 331. For FIGS. 14A to 14D, the content regarding operation of the push-in structure of the locking structure 302 for mounting the storage medium 390 in the socket 331 and operation of the push-pull structure of the locking structure 302 for discharging the storage medium 390 from the socket 331 described above with reference to FIG. 8, and 9A to 9D may be applied identically or similarly. For example, according to the push-in and push-pull structure of the locking structure 302, a phenomenon may occur in which the storage medium 390 becomes jammed in the socket 331 so that the locking bar 350 and the operation cam 380 may not operate normally. FIG. 14D may show a state in which the storage medium 390 is completely inserted and/or a phenomenon occurs in which the storage medium 390 becomes jammed in the socket 331 due to friction or the like. When the storage medium 390 is jammed in the socket 331, the storage medium 390 may be discharged using the push-tool T as illustrated in FIG. 14E.

Referring to FIG. 14E, the operation cam 380 may be pressed in the second direction (e.g., arrow direction of FIG. 14E or +X direction) by the push-tool T contacting the inclined surface (e.g., the inclined surface 3811 of FIGS. 13A and 13B). According to an embodiment, the inclined surface 3811 of the operation cam 380 may be pressed by the push-tool T in a third direction (e.g., +Z direction) that intersects a first direction (e.g., −X direction) in which the storage medium 390 is inserted into the socket 331 and a second direction (e.g., +X direction) opposite to the first direction. According to an embodiment, when the inclined surface 3811 is pressed in the third direction (e.g., +Z direction) by the push-tool T, the entire operation cam 380 may be configured to move in the second direction (e.g., +X direction). For example, the push-tool T may be inserted inside the socket 331 and the housing 320 through the second through hole 329a. According to an embodiment, when the operation cam 380 is moved in the second direction (e.g., +X direction), the storage medium 390 may be moved in the second direction (e.g., +X direction) by the operation cam 380 and discharged to the outside of the electronic device (e.g., the electronic device 101 of FIGS. 1 to 5).

Generally, an electronic device may include a separate space and/or a separate component such as a socket inside a housing to receive a storage medium (e.g., subscriber identification module card and/or memory card). For example, as a mechanical structure for separating a storage medium from a housing, a push-pull structure or a pivoting lever structure may be utilized. When a push-pull structure is applied, a jamming phenomenon of a storage medium may occur due to friction between a socket and the storage medium disposed in the socket or the size of the storage medium.

Aspects of the disclosure are to address at least the above-described problems and/or disadvantages, and to provide at least the advantages described below. The locking structure according to an embodiment of the disclosure may enable self-repair using the push-tool T by a user when unable to discharge it from the socket with the push-pull structure.

However, the objects of the disclosure are not limited to the above-mentioned problems and may be variously expanded within a range not departing from the spirit and scope of the disclosure. The effects that may be obtained from this disclosure are not limited to the effects mentioned above, and various effects that may be directly or indirectly identified through the disclosure may be provided.

The locking structure of the disclosure and the electronic device including the locking structure described above are not limited by the above-described embodiments and drawings, and it is apparent to those of ordinary skill in the art to which the disclosure pertains that various substitutions, modifications, and changes are possible within the technical scope of the disclosure.

According to an embodiment of the disclosure, an electronic device 101 may be provided. The electronic device may include a housing 320 including a first through hole 325 and a second through hole 326, a socket 331 disposed inside the housing and configured to seat a storage medium 390 inserted in a first direction through the first through hole, and a locking structure 302 disposed in the socket. The locking structure may include an operation cam 340; 390 configured to be movable with the storage medium, a locking bar 350 configured to allow or restrict movement of the operation cam, and an elastic member 360 disposed to press the operation cam in a second direction opposite to the first direction. When the operation cam is moved in the first direction or the second direction based on a pressing force of a push-tool T inserted into the socket through the second through hole, the storage medium disposed in the socket may be moved in the second direction and discharged to the outside of the electronic device.

According to an embodiment, the release lever may be rotatably disposed on the socket with respect to a rotation axis.

According to an embodiment, the release lever may be configured to push the storage medium in the second direction based on a pressing force of the operation cam.

According to an embodiment, the second through hole may face the operation cam. The operation cam may be pressed in the first direction using a push-tool T inserted into the socket through the second through hole.

According to an embodiment, the operation cam may include a protrusion 341 configured to press a portion of the release lever according to movement of the operation cam.

According to an embodiment, the release lever may include a first end 371 contactable to the operation cam and a second end 373 contactable to the storage medium in a state in which the storage medium is disposed in the socket.

According to an embodiment, the release lever may be configured to be rotatable about a rotational shaft 372 located between the first end and the second end. When the operation cam presses the first end, the release lever may be configured to rotate so that the second end presses the storage medium.

According to an embodiment, the operation cam may be configured to move in the second direction based on a pressing force of the operation release lever and push the storage medium in the second direction.

According to an embodiment, the second through hole may face the release lever. The release lever may be pressed in the first direction using a push-tool inserted into the socket through the second through hole.

According to an embodiment, the release lever may include a first end 371 contactable to the push-tool and a second end 373 contactable to the operation cam.

According to an embodiment, the release lever may be configured to be rotatable about a rotation axis located between the first end and the second end and, when the push-tool presses the first end, the release lever may be configured to rotate so that the second end presses the operation cam.

According to an embodiment, the operation cam may include a seating area 344 where a portion of the storage medium is seated and a stepped portion 345 formed around the seating area and limiting movement of the storage medium in the first direction.

According to an embodiment, the locking structure may further include an elastic member 360 providing an elastic force pressing the operation cam in the second direction.

According to an embodiment, the operation cam may further include a guide path 343 recessed on one surface.

According to an embodiment, one end of the locking bar may be provided to be movable within the guide path in response to movement of the operation cam, and another end of the locking bar may be configured to provide a rotation axis of the locking bar.

According to an embodiment of the disclosure, an electronic device 101 may be provided. The electronic device may include a housing 320 including a first through hole 325 and a second through hole 326; 329a, a socket 331 disposed inside the housing and configured to seat a storage medium 390 inserted in a first direction through the first through hole, and a locking structure 302 disposed in the socket. The locking structure may include an operation cam 340; 380 configured to be movable with the storage medium a locking bar 350 configured to allow or restrict movement of the operation cam, and an elastic member 360 disposed to press the operation cam in a second direction opposite to the first direction. When the operation cam is moved in the first direction or the second direction based on a pressing force of a push-tool T inserted into the socket through the second through hole, the storage medium disposed in the socket may be moved in the second direction and discharged to the outside of the electronic device.

According to an embodiment, the operation cam may include an inclined surface 3811 at one end, and the inclined surface of the operation cam may face the second through hole in a state in which the storage medium is disposed in the socket.

According to an embodiment, when the inclined surface of the operation cam is pressed in a direction intersecting the first direction and the second direction by a push-tool passing through the second through hole, the operation cam and the storage medium may be moved in the second direction.

According to an embodiment, the housing may include a rear plate and a side structure disposed at an edge of the rear plate. The first through hole may be formed in the side structure and the second through hole 329a may be formed in the rear plate.

According to an embodiment, the locking structure may further include a release lever 370 rotatably disposed on the socket with respect to a rotation axis.

The disclosure has been described by illustrating embodiment(s), but it should be understood that the above-described embodiment(s) are for illustration and not limiting the disclosure. It is apparent to those skilled in the art that various changes may be made in the form and detailed configuration within the entire perspective of the disclosure without departing from the scope including the appended claims and their equivalents.

The electronic device according to an embodiment of the disclosure may be one of various types of electronic devices. The electronic devices may include, for example, a portable communication device (e.g., a smartphone), a computer device, a portable multimedia device, a portable medical device, a camera, a wearable device, or a home appliance. According to an embodiment of the disclosure, the electronic devices are not limited to those described above.

An embodiment of the disclosure and terms used therein are not intended to limit the technical features described in the disclosure to specific embodiments, and should be understood to include various modifications, equivalents, or substitutes of the embodiment. As used herein, each of such phrases as “A or B,” “at least one of A and B,” “at least one of A or B,” “A, B, or C,” “at least one of A, B, and C,” and “at least one of A, B, or C,” may include all possible combinations of the items enumerated together in a corresponding one of the phrases. As used herein, such terms as “1st” and “2nd,” or “first” and “second” may be used to simply distinguish a corresponding component from another, and does not limit the components in other aspect (e.g., importance or order). It is to be understood that if an element (e.g., a first element) is referred to, with or without the term “operatively” or “communicatively”, as “coupled with,” “coupled to,” “connected with,” or “connected to” another element (e.g., a second element), it means that the element may be coupled with the other element directly (e.g., wiredly), wirelessly, or via a third element.

As used herein, the term “module” may include a unit implemented in hardware, software, or firmware, and may interchangeably be used with other terms, for example, “logic,” “logic block,” “part,” or “circuitry”. A module may be a single integral component, or a minimum unit or part thereof, adapted to perform one or more functions. For example, according to an embodiment, the module may be implemented in a form of an application-specific integrated circuit (ASIC).

An embodiment of the disclosure may be implemented as software (e.g., the program 140) including one or more instructions that are stored in a storage medium (e.g., internal memory 136 or external memory 138) that is readable by a machine (e.g., the electronic device 101). For example, a processor (e.g., the processor 120) of the machine (e.g., the electronic device 101) may invoke at least one of the one or more instructions stored in the storage medium, and execute it, with or without using one or more other components under the control of the processor. This allows the machine to be operated to perform at least one function according to the at least one instruction invoked. The one or more instructions may include a code generated by a compiler or a code executable by an interpreter. The storage medium readable by the machine may be provided in the form of a non-transitory storage medium. Wherein, the term “non-transitory” simply means that the storage medium is a tangible device, and does not include a signal (e.g., an electromagnetic wave), but this term does not differentiate between where data is semi-permanently stored in the storage medium and where the data is temporarily stored in the storage medium.

According to an embodiment, a method according to an embodiment of the disclosure may be included and provided in a computer program product. The computer program products may be traded as commodities between sellers and buyers. The computer program product may be distributed in the form of a machine-readable storage medium (e.g., compact disc read only memory (CD-ROM)), or be distributed (e.g., downloaded or uploaded) online via an application store (e.g., Play Store™), or between two user devices (e.g., smartphones) directly. If distributed online, at least part of the computer program product may be temporarily generated or at least temporarily stored in the machine-readable storage medium, such as memory of the manufacturer's server, a server of the application store, or a relay server.

According to an embodiment, each component (e.g., a module or a program) of the above-described components may include a single entity or multiple entities. Some of the plurality of entities may be separately disposed in different components. According to an embodiment, one or more of the above-described components may be omitted, or one or more other components may be added. Alternatively or additionally, a plurality of components (e.g., modules or programs) may be integrated into a single component. In such a case, according to various embodiments, the integrated component may still perform one or more functions of each of the plurality of components in the same or similar manner as they are performed by a corresponding one of the plurality of components before the integration. According to various embodiments, operations performed by the module, the program, or another component may be carried out sequentially, in parallel, repeatedly, or heuristically, or one or more of the operations may be executed in a different order or omitted, or one or more other operations may be added.

While the disclosure has been shown and described with reference to various embodiments thereof, it will be understood by those skilled in the art that various changes in form and details may be made therein without departing from the spirit and scope of the disclosure as defined by the appended claims and their equivalents.

What is claimed is:

1. An electronic device comprising:
a housing including a first through hole and a second through hole formed around the first through hole;
a socket disposed inside the housing and configured to seat a storage medium inserted in a first direction through the first through hole; and
a locking structure disposed in the socket,
wherein the locking structure includes:
an operation cam configured to be movable with the storage medium,
a locking bar configured to allow or restrict movement of the operation cam, and
a release lever, and
wherein the locking structure is configured to hold the storage medium disposed in the socket or move the storage medium disposed in the socket in a second direction opposite to the first direction by using at least one of the operation cam or the release lever to discharge the storage medium through the first through hole to the outside of the electronic device.

2. The electronic device of claim 1, wherein the release lever is disposed to be rotatable with respect to a rotation axis on the socket.

3. The electronic device of claim 2, wherein the release lever is configured to push the storage medium in the second direction based on a pressing force of the operation cam.

4. The electronic device according to claim 3,
wherein the second through hole faces the operation cam, and
wherein the operation cam is configured to be pressable in the first direction using a push-tool inserted into the socket through the second through hole.

5. The electronic device according to claim 4, wherein the operation cam includes a protrusion configured to press a part of the release lever according to movement of the operation cam.

6. The electronic device according to claim 5, wherein the release lever includes a first end contactable to the operation cam and a second end contactable to the storage medium in a state in which the storage medium is disposed in the socket.

7. The electronic device of claim 6,
wherein the release lever is configured to be rotatable with respect to a rotational shaft located between the first end and the second end, and
wherein, when the operation cam presses the first end, the release lever is configured to be rotated so that the second end presses the storage medium.

8. The electronic device of claim 2, wherein the operation cam is configured to move in the second direction based on a pressing force of the release lever and push the storage medium in the second direction.

9. The electronic device of claim 8,
wherein the second through hole faces the release lever, and
wherein the release lever is configured to be pressable in the first direction using a push-tool inserted into the socket through the second through hole.

10. The electronic device of claim 9, wherein the release lever includes a first end contactable to the push-tool and a second end contactable to the operation cam.

11. The electronic device of claim 10,
wherein the release lever is configured to be rotatable with respect to a rotational shaft located between the first end and the second end, and
wherein, when the push-tool presses the first end of the release lever, the release lever is configured to be rotated so that the second end presses the operation cam.

12. The electronic device according to claim 11, wherein the operation cam comprises:
a seating area where a portion of the storage medium is seated; and
a stepped portion formed around the seating area and limiting movement of the storage medium in the first direction.

13. The electronic device according to claim 12, wherein the locking structure further comprises an elastic member providing an elastic force for pressing the operation cam in the second direction.

14. The electronic device according to claim 13,
wherein the operation cam further comprises a guide path recessed on one surface of the operation cam, and
wherein one end of the locking bar is provided to be movable within the guide path in response to movement of the operation cam, and another end of the locking bar is configured to provide a rotation axis of the locking bar.

15. An electronic device comprising:
a housing including a first through hole and a second through hole;
a socket disposed inside the housing and configured to seat a storage medium inserted in a first direction through the first through hole; and
a locking structure disposed in the socket,
wherein the locking structure includes:
an operation cam configured to be movable with the storage medium,
a locking bar configured to allow or restrict movement of the operation cam, and
an elastic member disposed to press the operation cam in a second direction opposite to the first direction, and
wherein when the operation cam is moved in the first direction or the second direction based on a pressing force of a push-tool inserted into the socket through the second through hole, the storage medium disposed in the socket is moved in the second direction and discharged to the outside of the electronic device.

16. The electronic device according to claim 15,
wherein the second through hole faces the operation cam, and
wherein the operation cam is configured to be pressable in the first direction using a push-tool inserted into the socket through the second through hole.

17. The electronic device according to claim 15, wherein the operation cam comprises:
a seating area where a portion of the storage medium is seated; and
a stepped portion formed around the seating area and limiting movement of the storage medium in the first direction.

18. The electronic device according to claim 15,
wherein the operation cam further comprises a guide path recessed on one surface of the operation cam, and
wherein one end of the locking bar is provided to be movable within the guide path in response to movement of the operation cam, and another end of the locking bar is configured to provide a rotation axis of the locking bar.
